(19) United States
(12) Patent Application Publication
(10) Pub. No.: US 2014/0034848 A1
(43) Pub. Date: Feb. 6, 2014

(54) PHOTON TURBINE GENERATOR FOR POWER GENERATION

(71) Applicant: Brian Campbell, Parsippany, NJ (US)

(72) Inventor: Brian Campbell, Parsippany, NJ (US)

(21) Appl. No.: 13/566,474

(22) Filed: Aug. 3, 2012

(51) Int. Cl. G21K 5/00; F02D 29/06; F01D 15/10

(52) U.S. Cl. 250/492.1; 290/52; 290/7

(57) ABSTRACT

A method and device for generating power using radiation pressure is described. The device comprises a turbine generator in which the turbine comprises optical resonant cavities or waveguides. The turbine rotates as a result of the force applied to the resonant cavities or waveguides by the radiation pressure of the circulating laser beam. Because of the amplification of the power of the input laser beam through resonant enhancement, the Photon Turbine Generator (PTG) has the potential for overunity efficiency (i.e., power output exceeding power input), lasting until the laser pumping mechanism or gain medium degrades or expires. The PTG may be built on either a macroscopic or microscopic scale. The PTG can provide clean, efficient, long-lasting power for diverse applications (e.g., energy, transportation, and electronic devices), while also supplying electricity to meet its own operational needs (e.g., laser pump power).

### BACKGROUND

1. Field of the Disclosure

This invention relates to a system and method of generating motive power, and more specifically to a system and method of generating motive power that uses radiation pressure to apply mechanical force to a turbine comprising one or more optical resonant cavities or waveguides.

2. Brief Discussion of Related Art

When electromagnetic (EM) radiation interacts with matter, it imparts a very small physical force onto it, which is known as radiation pressure (also known as photon pressure or light pressure). This force is approximately 6.67 newtons per gigawatt of EM radiation, assuming the photons are reflected rather than absorbed, and is independent of the wavelength of the EM radiation. Radiation pressure was first demonstrated experimentally in 1900 by P. N. Lebedev, whose findings confirmed James Clerk Maxwell's theory that EM waves exert radiation pressure.

Radiation pressure is not a particularly well known subject outside of certain fields such as laser physics and astrophysics. Even within these fields, radiation pressure is sometimes viewed as merely a byproduct of other optical phenomena or a nuisance to be corrected for. For example, the radiation pressure of sunlight on GPS satellites causes slight perturbations to their orbits, which must be compensated for to maintain the accuracy of the system, which depends on knowing the precise locations of the satellites at a given time.

One interesting application of radiation pressure is the solar sail, which is a method of space transportation that utilizes a large thin reflective sheet, or sail, to reflect EM radiation from the sun. When photons in the sunlight bounce off the sail, they transfer their momentum, causing gradual acceleration of the solar sail. Detailed analyses of solar sails have been performed since the 1950s. In 2010, the Japanese Aerospace Exploration Agency (JAXA) successfully tested a solar sail, called IKAROS (Interplanetary Kite-craft Accelerated by Radiation of the Sun), confirming acceleration due to the force of radiation pressure from sunlight.

An interesting variation of the solar sail is the laser sail. The laser sail is based on the same concept as the solar sail. However, instead of harnessing sunlight, a laser beam is used to apply radiation pressure to the sail. The power density of a laser beam could be much higher than sunlight, enabling greater acceleration of the spacecraft. Because there is minimal countervailing force in space, due to the frictionless vacuum, a laser sail could continue to accelerate until reaching great speeds, approaching those of light itself. Aside from experimental spacecraft and specialized applications such as optical tweezers, radiation pressure remains a relatively marginal phenomenon in terms of practical use.

### SUMMARY

In order to overcome these and other weaknesses, drawbacks, and deficiencies in the known art, it is the aim of the present disclosure to describe a Photon Turbine Generator (PTG) to harness radiation pressure to perform useful work in an Earth-based or macroscopic application (although the PTG can be used in space and on a microscopic scale as well). Under suitable conditions, radiation pressure can provide the motive force for a power generator. One key to making radiation pressure a worthwhile motive force for a power generator is to recycle the EM radiation, thereby maximizing the number of photon bounces off of mirrors or other reflective surfaces. This recycling of photons may be accomplished with a resonant cavity or a waveguide. Thus, a low power input laser beam may achieve a high circulating power inside the cavity or waveguide. With mirrors or reflective surfaces of sufficiently high quality, the power amplification inside of a resonant cavity or closed-loop waveguide can enable the PTG to produce more power than it consumes for a temporary period of time. This time period would be determined primarily by the lifetime of the input laser. For example, a laser pumping mechanism and gain medium allowing for 500,000 hours of continuous operation before degrading or expiring would enable the PTG to operate continuously for 500,000 hours, assuming the other components of the PTG (e.g., bearings, field windings) are well maintained and operate properly.

It is important to note that the “overunity” efficiency (a higher output power than input power) of the PTG does not violate the Second Law of Thermodynamics. After start up, if left to itself, the PTG would eventually cease operating, due to the gradual degradation of the laser pumping mechanism or gain medium, as well as the normal wear and tear of other key components. Overunity efficiency in the limited sense described herein however should be attainable with presently existing technology. Even with efficiency below 100%, a PTG could still be a useful and important source of power by using solar pumping to produce the input laser beam. A solar-pumped PTG could be especially useful in a power plant application.

In addition to its potential for overunity efficiency, the PTG has several other desirable properties, such as zero emissions, a high power density, and substantial scalability. The PTG can provide power or electricity for numerous applications, including power plants, transportation systems, industrial equipment, power tools, electronic devices, and microscopic and nanoscopic devices.

The presently disclosed embodiments of the Photon Turbine Generator (PTG) use radiation pressure (photon pressure, light pressure, etc.) to apply mechanical force to a turbine comprising mirrors or reflective surfaces for the purpose of generating motive or other forms of power. These mirrors or reflective surfaces form resonant cavities or closed-loop waveguides to comprise the photon turbine section of the PTG. The generator section of the PTG may comprise any type of conventional electrical generator, including an AC generator, AC alternator, DC generator, or any other type of electrical generator. The PTG in general, and the photon turbine in particular, may be configured in numerous ways, as shown in the accompanying drawings. Many different resonator geometries could be devised, especially with the use of computer-aided design software.

The preferred embodiments of the PTG depend on several factors, including manufacturing and engineering considerations, economic costs, and the power density requirements of the specific application being powered by the PTG.

The photon turbine comprises a group of mirrors or reflective surfaces forming one or more resonant cavities or waveguides. Mirror mounts or other structures securely attach the mirrors or reflective surfaces to a housing unit, which is depicted as a cylindrical fairing in this specification. Each mirror or reflective surface in the resonant cavities or waveguides mounted on the photon turbine receives a high-reflectance (HR) coating, such as a multilayer dielectric coating. The reflectivity of these mirrors or reflective surfaces should be as high as possible (>99.9999%) to provide the highest possible forces from radiation pressure. The photon turbine may include a laser generator, which may be mounted either inside the resonator, forming an active resonant cavity, or outside the resonator, forming a passive resonant cavity. Alternately, the laser generator may be kept separate from the photon turbine and positioned at another location. In the latter case, the laser beam may be injected into the photon turbine, where it would then be inserted into the resonant cavities or waveguides using optical components such as mirrors or lenses mounted on the photon turbine. The laser generator comprises components necessary to produce a laser beam, which may include a gain medium, a mechanism to pump or stimulate the gain medium, and mirrors or reflective surfaces, as well as other components or devices.

In theory, any laser may be used for the PTG, including but not limited to solid-state lasers, crystal lasers, diode lasers, semiconductor lasers, semiconductor diode lasers, fiber lasers, photonic crystal fiber lasers, gas lasers, liquid lasers, dye lasers, excimer lasers, free-electron lasers, laser diode stacks, laser diode bars, laser diode multi-bar modules, laser diode arrays, two-dimensional diode laser arrays, broad stripe laser diodes, broad area laser diodes, broad emitter laser diodes, single-emitter laser diodes, high brightness diode lasers, edge-emitter laser diodes, external cavity diode lasers, fiber-coupled diode lasers, vertical cavity surface-emitting lasers, vertical-external-cavity surface-emitting lasers, double heterostructure lasers, separate confinement heterostructure lasers, horiozontal stripe lasers, distributed feedback lasers, quantum well lasers, quantum cascade lasers, slab-coupled optical waveguide lasers, distributed Bragg reflector lasers, Bessel beams, diode-pumped lasers, optically pumped lasers, laser-pumped lasers, light pumped lasers, solar pumped lasers, nuclear-pumped lasers, electric-discharge lasers, chemical lasers, gas-dynamic lasers, ion lasers, metal-vapor lasers, samarium lasers, Raman lasers, tunable lasers, disk lasers, thin-disk lasers, rotary disk lasers, slab lasers, rod lasers, spherical lasers, optical parametric oscillators, superradiant lasers, diffuse random lasers, nanostructured lasers, nanolasers, vibronic lasers, terahertz lasers, microwaves, noncoherent or incoherent light, or sunlight. Efficiency and laser lifetime are important factors in deciding which type to use. A diode laser, diode-pumped solid-state laser, or CO2 laser may be suitable choices.

Another important factor in selecting a laser is its suitability for use in a power enhancement cavity. Any type of gain medium may be used, including without limitation solids, crystals, liquids, gases, and microwave crystals. Multilayer dielectric mirrors are often designed to reflect a specific wavelength with a very high reflectivity. Because mirrors of the highest possible reflectivity are preferable for the PTG, laser wavelengths that can be reflected at >99.9999% reflectivity may be preferable. The embodiments of the PTG described in this specification use laser resonators. However, it is important to note that other types of EM radiation, such as microwaves, could also be used in a PTG. The force of radiation pressure is provided by electromagnetic radiation from any part of the electromagnetic spectrum, including but not limited to optical, infrared, near-infrared, mid-infrared, far infrared, microwave, ultraviolet, x-rays, gamma rays, or radio waves. A single beam of input and/or circulating EM radiation, or multiple beams of input and/or circulating EM radiation, which may be from any part of the EM spectrum and operate in any mode individually or in combination, may be used. However, the laser is presently considered a convenient form of EM radiation to use in a PTG.

In addition to the resonant cavities or waveguides, and potentially the laser generator, the photon turbine may also contain optical or electrical components that support the operation of the resonant cavities or waveguides. These components may include lenses or prisms to help insert the laser beam into the resonant cavities or waveguides; piezoelectric transducers (PZTs) or piezo-controlled mirror actuators to help adjust the orientation of the mirrors or reflective surfaces for optimal resonator performance; and electrical wiring, electrodes, diodes, flash lamps, or other devices used to pump the input laser or stimulate the gain medium (if the gain medium is placed on the turbine). Other components contained by the photon turbine may include filters, optical diodes, optical isolaters, Pockels cells, mixers, polarizers, and servosystems, any type of known device may be used to pump or stimulate the gain medium, or serve as an excitation source, including but not limited to diodes, electrodes, lamps, flash lamps, arc lamps, sunlight, electronic impact excitation, chemical reactions, nuclear reactions, solid-state lasers, diode lasers, fiber lasers, gas lasers, liquid lasers, excimer lasers, free-electron lasers, solar pumped lasers, and microwave generators. In addition, the laser may be produced by spontaneous emission or by gain media that do not require pumping or stimulation by an external process.

Also, the turbine may contain various heat dissipation devices for thermal management of the gain medium and to help prevent damage to the mirrors or reflective surfaces from the high intensity circulating laser beam. Heat removed from the mirrors or reflective surfaces may be delivered to the photon turbine fairing and then transferred to the ambient air or ambient atmosphere (or transferred to the vacuum, if the PTG is located in space).

The photon turbine fairing is intended to provide an enclosed environment for optimal resonator performance. To achieve maximum power enhancement in the resonant cavities or waveguides, which will maximize the force applied to the mirrors or reflective surfaces, the interior of the photon turbine should be evacuated. By maintaining a high vacuum inside the photon turbine, there will be few or essentially no air molecules to reduce the intensity of the circulating laser beam. However, the PTG may operate under various pressure regimes, including no vacuum, rough vacuum, partial vacuum, high vacuum, ultrahigh vacuum, complete vacuum, and the vacuum of outer space.

In addition to sealing the resonators (the term “resonator” comprises both resonant cavities and waveguides in this specification) from the ambient atmosphere, the fairing also provides an aerodynamic shell that allows for efficient high speed operation of the PTG. Even if the resonators were able to provide sufficient torque to accelerate the PTG in the ambient atmosphere, the flat (or curved) surfaces of the mirrors or reflective surfaces would produce significant atmospheric drag, especially at high rotational speeds. Thus, an aerodynamic fairing should be used to contain the resonant cavities or waveguides and maintain the conditions for their optimal performance. In certain contemplated uses of the PTG, e.g., one which is located in the vacuum of outer space, the usefulness of a fairing diminishes. While such application will indicate that some type of protective enclosure might still be desirable, e.g., to protect the mirrors from micrometeoroids, a PTG could operate in the vacuum of space without a fairing.

The fairing may be constructed from various substances, such as metal, composite materials, ceramic, glass, plastic, or other materials. The choice of the type and thickness of the material may depend on the size of the PTG and the amount of torque the fairing will be subjected to. Advantageous properties for the fairing may include rigidity, strength to withstand torque applied to its inner surface, the ability to rotate at high angular speeds, and the ability to serve as a vacuum enclosure.

In certain embodiments the photon turbine is mounted on a shaft that also contains a rotor, which is surrounded by a stator. The rotor-stator combination may be a conventional design. Either the rotor or the stator may contain field windings. The shaft may be supported by conventional bearings or bearings optimized for high speed rotation, such as magnetic bearings.

Throughout this specification, the generator component of the PTG is depicted as an AC generator. The rotor contains the field winding and the stator contains the armature winding. This presentation is based on the most commonly used method of generating electricity at power plants. The photon turbine could instead be coupled to a DC generator or any other type of electrical generator. In addition, a photon turbine could be directly coupled to a mechanical device, where it could provide mechanical power without producing electricity. Because the PTG may provide an important new method of generating electricity at power plants, the present disclosure portrays the electrical generator component of the PTG as an AC generator. But the PTG could be coupled with many different types of electrical generator and is not limited to being coupled with an AC generator.

The size of the PTG may vary, depending on the application. The components of the PTG may be built at various scales. It is possible to construct a PTG with a photon turbine the size of a wine cork, which might provide electricity to a handheld power tool. A larger PTG, perhaps with a photon turbine the size of a small garbage can, could provide power to a car. A PTG similar in size to an existing gas turbine or steam turbine could generate electricity at a power plant. Miniaturized PTGs could provide power for microscopic and nanoscopic devices. PTGs on a vast scale, perhaps with diameters of several kilometers or more, could be constructed and operated in space. Any size of a Photon Turbine Generator (PTG) or other components may be used, including but not limited to nanoscale, microscopic scale, and macro-scale. In layman's terms, without limiting the range described, the diameter of the photon turbine may vary from very small-sized (e.g. head of a pin), small-sized (e.g., coin sized), medium-sized (e.g., dinner plate sized), large-sized (e.g., Ferris Wheel sized), very large sized (e.g., 1 to 10 km), and ultra-large-sized (e.g., ≧10 km), depending upon the application.

Because mirrors do not have perfect (100%) reflectivity, a very small percentage of the circulating laser beam in the PTG will be transmitted, absorbed, or scattered by the mirrors or reflective surfaces. Even with high reflectivity mirrors or reflective surfaces, the temperature of the mirrors or reflective surfaces may increase significantly due to their exposure to intense electromagnetic radiation. Given the vacuum conditions that may be created inside of the fairing, the preferred method of removing heat is radiation. Therefore, the back side of the mirrors or reflective surfaces may comprise a material or substrate with high thermal radiation properties. Once the heat is radiated from the mirrors or reflective surfaces, it can be absorbed by the fairing, where it can then be transferred to the ambient air. If active cooling is required, various methods may be used. Some of these methods, including heat pipes and cooling conduits, are discussed in this specification.

The core of the PTG is the resonant cavity or waveguide. Input laser beams are injected into the resonant cavities or waveguides, where they are amplified to form substantially more intense circulating laser beams. State of the art high reflectance (HR) mirrors are capable of reflectance of >99.9999%. Any type of reflective surface or boundary condition may be used in the resonator, including but not limited to multilayer dielectric coatings, single-layer dielectric coatings, multilayer dielectric gratings, single-layer dielectric gratings, oxides, semiconductors, silica, glasses, thin films, Bragg mirrors, Bragg gratings, circular Bragg gratings, distributed Bragg reflectors, distributed Bragg grating reflectors, chirped mirrors and photonic crystals. The PTG should use mirrors with the maximum possible reflectivity to provide the highest possible force from radiation pressure. With a mirror of 99.99999% reflectivity, the circulating power of the laser beam inside the resonant cavity or waveguide will be approximately 10 million times greater than the power of the input laser beam. It is this principle of amplification, or power build-up, inside the resonant cavity or waveguide that enables the PTG to achieve overunity (>100%) efficiency. Unlike most laser resonators, in which a percentage of the circulating beam is expected to exit the cavity, the circulating laser beam of the PTG should remain inside the cavity. In the PTG, the circulating laser beam performs useful mechanical work by reflecting off the resonator mirrors and imparting forces due to radiation pressure onto them. The greater the reflectivity of the mirrors, the greater the amplification of the circulating laser beam, which results in increased force due to radiation pressure. Thus, unlike the vast majority of resonators currently used, there is no need for the laser beam to exit the resonators of the PTG.

The force on the resonator mirrors from radiation pressure is transferred through the mirror mounts to the fairing. The mirror mounts are primarily support structures that connect the resonator mirrors to the fairing. While they could be designed to be adjustable, which may help optical engineers align the resonator mirrors when constructing and testing PTGs, they are mainly intended to transfer force from the mirrors to the fairing. In addition, the mirror mounts may have secondary functions in distributing components of a feedback control system to the resonator mirrors and facilitating heat transfer from the mirrors. Furthermore, the mirror mounts could be used to help mount or secure a laser generator and/or other components behind the input mirror of a passive resonant cavity.

It is important to note that the PTG is not a perpetual motion device. The PTG does not violate the Second Law of Thermodynamics. The gain medium and the components used to pump the laser will eventually degrade and expire over time. These items will have to be replaced periodically. In addition, the electrical and mechanical components of the PTG will eventually require maintenance and/or replacement, due to gradual wear and tear. Thus, overunity efficiency allows the PTG, after initial start up, to operate independently for a period of time that is determined primarily by the longevity of the gain medium and/or laser pumping components. These components could potentially be designed to last for many years.

When the resonant cavities or waveguides are established, the PTG will rotate as a result of the force due to radiation pressure that the circulating laser beam applies to the mirrors or reflective surfaces of the resonant cavities or waveguides. The photon turbine will continue to accelerate until it reaches the desired operating speed (e.g., 1800 rpm or 3600 rpm). The rotational speed of the PTG can be controlled by adjusting the power of the input laser beam, which will modify the power of the laser beam circulating in the resonant cavity or waveguide, thereby controlling the torque applied to the PTG. Also, a conventional braking system can be used to control speed. Furthermore, the rotational speed of the PTG will ultimately be restricted by the consumption of its power output, which will apply a counteracting torque to the rotor.

The primary determinants of the amount of force due to radiation pressure that can be applied to the PTG are:
The total surface area of the mirrors or reflective surfaces. This is the amount of space that is allocated to receive the force of radiation pressure;
The reflectivity of the mirrors or reflective surfaces. This determines the degree of amplification or power enhancement that can be achieved by the resonant cavities or waveguides; and
The optical damage threshold of the mirrors or reflective surfaces. This determines the maximum potential circulating power of the laser beam and amount of radiation pressure that may be applied to the mirrors or reflective surfaces.

Once the total surface area, reflectivity, and optical damage threshold of the mirrors or reflective surfaces are established, the amount of torque produced by the PTG is determined by:
The total circulating power of the laser beams inside of the resonant cavities or waveguides. This is determined by the power of the input laser beam and the degree of amplification of the laser beam inside each resonant cavity or waveguide;
The distance of the mirrors or reflective surfaces from the axis of rotation. If the mirrors or reflective surfaces are positioned further from the axis of rotation, they will apply greater torque for a given amount of force;
The angle of incidence of the circulating laser beam on the mirrors or reflective surfaces. When a laser beam strikes a perfect (100% reflectivity) mirror or reflective surface perpendicularly, the force from radiation pressure is 2 P/c. However, if the incident angle of the laser beam is oblique, then the force from radiation pressure is 2 P(cos²θ)/c. The fact that the cosine of the incident angle is squared in this equation is a significant factor when designing resonant cavities or waveguides for the PTG. When some mirrors or reflective surfaces receive perpendicular incident laser beams, and other mirrors or reflective surfaces receive laser beams with oblique angles of incidence, it can help to create an imbalance of torques leading to rotation of the photon turbine; and
The angle that the mirrors or reflective surfaces make with the lever arm. For a given amount of force, a force that is perpendicular to a lever arm will produce more torque than a force applied at an oblique angle to a lever arm.

Maximizing the force of the radiation pressure applied to the resonator mirrors is a beneficial aspect of the PTG. However, to rotate the PTG, an imbalance of torques must be created. Thus, even if extremely high reflectance mirrors helped to produce an extremely powerful circulating laser beam, which produces substantial forces due to radiation pressure, the PTG will not rotate if the sum of the torques acting on the resonant cavities or waveguides counteract each other and cancel out.

While laser beams circulate inside one or more resonators, the structure on which the mirrors or reflective surfaces are mounted (shown as a cylindrical fairing in certain embodiments described herein) will rotate. During the time it takes a photon to make one round trip inside the resonator, the amount of rotation of the shaft is extremely small. This extremely small degree of rotation will result in a very slight change in the angle of the resonator mirror or reflective surface relative to the photon returning to the mirror or reflective surface after making one round trip. The slight angle change will also lead to a very small change in the total round trip length of the photon. To ensure resonator stability, conventional means, such as curved mirrors (e.g., spherical mirrors or long-radius mirrors), a feedback control system using piezoelectric transducers (PZT) or piezo-controlled mirror actuators or servosystems, and a reference cavity, may be used. Thus, the slight change in the angle of incidence and round trip distance caused by rotation of the PTG could be handled or adjusted for by using the same methods routinely used in resonators to compensate for gradual beam divergence and thermal distortion. Thus, the resonator might as well be stationary from an individual photon's perspective, because the laser beam will be refocused and realigned after each round trip. Furthermore, once the PTG reaches its nominal operating rotational speed (e.g., 3000 or 3600 rpm if used to drive a 50 or 60 Hz AC generator), the precise variation in the angle of incidence and round trip distance during a photon round trip can be calculated, which will facilitate any compensatory measures that may need to be taken to ensure resonator stability and maximum power enhancement. By using these means, the resonant cavities or waveguides in the PTG should remain stable. However, if the variation in the angle of incidence and round trip distance reduce resonator stability, various methods may be used to reduce variations in the positions of the mirrors or reflective surfaces:
Reduce the speed of operation of the PTG: Rather than operating at high speeds similar to a gas or steam turbine, the PTG could rotate at low speeds similar to a wind or water turbine. To help compensate for reduced speed, the mirror area or number of resonators in the PTG could be increased, providing greater torque;
Reduce the distance between the resonator mirrors: This would reduce the round trip time of the photons, enabling them to cycle through the resonant cavity or waveguide with less variation in the positions of the mirrors or reflective surfaces per photon round trip. This might involve reducing the size of the mirrors or reflective surfaces. However, the reduced size of the mirrors or reflective surfaces could be compensated for by placing additional resonant cavities or waveguides on the photon turbine. Thus, the photon turbine could contain numerous small-sized resonators instead of one or a few large-sized resonators; and
Reduce the distance of the resonant cavities from the shaft: While this would not change the angular variation of the mirrors per photon round trip, it would reduce variation in the total round trip length.

An important advantage of the PTG over existing generators is the flexibility of its design and operation. Existing turbines tend to favor a particular speed for optimal performance. Gas turbines and steam turbines typically rotate at high speeds, whereas hydroelectric turbines and windmills typically rotate at low speeds. The motive force tends to determine the rotational dynamics of the turbine. In contrast, a PTG could be designed to operate at either a high rotational speed or a low rotational speed. A massive turbine filled with numerous reflective surfaces could resemble the shape of a giant Ferris wheel and produce enormous torque while rotating at a low speed. Conversely, a microscopic PTG, possibly using magnetic bearings, could rotate at extremely high speeds. Furthermore, the scalability of the PTG is aided by the physics of radiation pressure. A photon that bounces off a reflective surface will impart the same force, regardless of whether it traveled one millimeter or one kilometer before reaching the surface. Therefore, the resonant cavities or waveguides of the PTG can be built at nearly any size.

The initial start-up power for the PTG may be provided by an existing power supply. However, once the PTG has reached its operating speed, it can produce enough power such that a percentage of its output may be diverted to provide electricity to stimulate the gain medium that produces the input laser. Thus, the PTG would be “self-pumped.” A self-pumped PTG is capable of operating for a long period of time—potentially for many years. The primary limiting factor would be the lifetime of the laser. This is why lasers with long lifetimes, such as diode lasers, may be preferable for the PTG. Diode lasers may have lifetimes that allow for over 100,000 hours of continuous operation. Other limiting factors for the PTG are the normal wear and tear of the electrical and mechanical equipment. Thus, the potential of the PTG for greater than 100% efficiency is a feature that has a limited duration—specifically, the lifetime of the gain medium and/or the laser pumping devices. Over time, the gain medium and laser pumping devices gradually degrade and eventually expire. However, these components may ultimately be reused. For example, the crystals of diode lasers or diode-pumped solid-state lasers could be recycled and re-fabricated for future use.

The circulating power of the laser beam inside the resonators of the PTG may be extremely high, especially in a large-scale configuration. Under normal operating conditions, circulating laser beams would be confined to the resonant cavities or waveguides. The simple fact that a circulating laser beam only achieves such a high power as a result of being trapped inside a resonator provides a built-in safety mechanism for the PTG. If a resonator mirror were to become misaligned or damaged, the resonator would be disrupted and the laser beam would very quickly revert to the relatively low power of the input laser beam. However, a brief, powerful laser pulse could be released if a resonator in a PTG were significantly disrupted. If such an event were to occur, it is important to prevent any stray laser pulse from penetrating the fairing and causing damage to people or property. Thus, consideration should be given to applying a coating to the inside of the fairing, which would reflect, scatter, absorb, or otherwise neutralize any laser beam or EM radiation that may exit the resonant cavities or waveguides. This safety barrier could comprise the same multilayer dielectric mirror coatings that may be used in the resonator. However, other materials and methods may also be used to help ensure the safety of people and the protection of property in the vicinity of an operating PTG.

In addition to creating one or more protective barriers, a control system could be developed that automatically deactivates the input laser beam if the PTG is subjected to a specific amount of vibration, shock, or other disturbance. Thus, if the fairing were damaged by an external force or foreign object, the control system would deactivate the input laser beam, resulting in the cessation of the circulating laser beam, thereby reducing the risk of a laser pulse exiting the PTG.

Safety considerations may also influence the selection of the laser for the PTG. Lasers of certain wavelengths are more likely to cause eye damage than others for a given intensity. Thus, minimizing the risk of eye damage to engineers, technicians, and consumers should be considered when deciding which laser to use in a PTG.

A PTG with overunity efficiency could be used to supply power for numerous applications, including power plants, vehicles, and electrical devices. After a sufficient number of PTGs are activated using start-up power from existing, conventional power plants, the PTGs could then be used to supply the start-up power for increasingly powerful PTGs. The amount of power that could be generated with an ever-expanding number of PTGs is virtually limitless. Also, the components of the PTG are relatively common and adjustable (e.g., numerous types of gain media could be used for the input laser; multilayer dielectric mirrors may be fabricated with substrates made of fused silica or alumina), so there should be no significant obstacles to obtaining resources for mass production of PTGs.

Use of the PTG in vehicles and transportation systems may require special vibration-dampening equipment. Resonant cavities may be sensitive to mirror misalignment and therefore using a PTG in an application that is subjected to significant vibrations may be disruptive of the PTG. Thus, consideration should be given to shock absorbing housing units in which to place the PTG. Also, magnetic bearings, which can keep the shaft in the appropriate position while a vehicle experiences vibration, turbulence, or high acceleration, may also be useful in transportation applications.

Another consideration for vehicular applications is the potential need for high power density (i.e., power output per unit mass of generator). Maximizing the optical damage threshold of the mirrors or reflective surfaces in the resonant cavities or waveguides would help to provide a high power density. For example, a mirror that can receive 1 GW/cm² of continuous power of EM radiation without damage could receive 100 times greater force due to radiation pressure than a mirror that can only receive 10 MW/cm² of continuous power without damage. Thus, a higher optical damage threshold can lead to significantly increased torque in a PTG for a given size of a mirror or reflective surface. For example, an optical damage threshold of 10 MW/cm² of continuous power might be suitable for a power plant, which would have ample space to operate a large PTG and would not be susceptible to any “weight penalty,” as there is no need to accelerate a power plant. However, for a vehicle, an optical damage threshold of 1 GW/cm² continuous power or higher may be useful, because the mirrors or reflective surfaces could receive significantly greater forces from radiation pressure for a given size and mass, thereby increasing the power density of the PTG.

In addition, the power density may be increased by maximizing the mirror surface area inside of the fairing. This may be achieved by filling the fairing with numerous resonators that are packed closely together. Broadly speaking, large quantities of resonators could be placed in a fairing in close formations, roughly similar to the fins of a heat sink or a grid-shaped grille. The resonators could be reduced to sizes comparable to a single wavelength of EM radiation enabling massive numbers of resonators to be placed inside of a photon turbine. For example, the amount of torque produced by the PTG could be substantially increased by filling the fairing with one million resonators, each with a width of approximately one micron, instead of using one or a few large-sized resonators. A PTG with a resonator packing density this high may be significantly more complex to build and operate, however, it is an important option to consider for applications that require a high power density.

Another way to increase the power density of the PTG is to increase the angular speed. A PTG could be designed to rotate significantly faster than 3600 rpm. To facilitate high-speed rotation, magnetic bearings could be used and a partial or full vacuum could be established around the fairing, shaft, and rotor. This could create outer-space-like conditions (frictionless vacuum) for optimal rotational dynamics.

While the extreme efficiency of the PTG is its most striking feature, it is also an improvement over existing power generators based on its zero emissions, scalability, power density, and precision controllability. The PTG produces zero emissions. The only byproducts of its operation, aside from waste heat, are the components that eventually expire due to gradual wear and tear. Some of these components, such as the gain media and laser pumping devices could be recycled and re-fabricated for future use. In addition, the PTG can be built on a wide range of scales. The components of the PTG (e.g., mirrors, lasers, magnets, vacuum chamber) can be fabricated on microscopic and macroscopic scales. The input beam of the laser or EM radiation, or circulating beam of the laser or EM radiation, may be of any size or diameter desired.

The PTG could provide power to numerous devices, including micro-machines, nano-machines, electronic gadgets, power tools, cars, and power plants. The PTG could also enable greater implementation of high-power applications, including desalination and indoor agriculture, without adversely affecting the environment. Ultra-large-size PTGs could be constructed in space (which removes the need to create a vacuum chamber), producing massive amounts of power for diverse applications, including space transportation, asteroid defense, and high-energy physics experiments. Furthermore, with mirrors or reflective surfaces of sufficiently high reflectivity, the power density (power output per unit mass) of the PTG may be significantly greater than existing power generators, facilitating the use of the PTG in transportation systems and other fields where independent, onboard power is needed. Furthermore, compared with many other types of power generators, the PTG is a precision device. The amount of force applied to the photon turbine can be directly controlled by adjusting the power of the input laser. This allows for clean, easily adjustable power, which may be useful for applications that require a consistent delivery of precise amounts of electricity.

An alternative embodiment of the PTG that does not require overunity efficiency to function is the solar-pumped PTG. Instead of having the PTG provide its own laser pump power, sunlight would be used to pump the laser. At solar thermal power plants, sunlight is collected using an array of mirrors. A similar array of mirrors could be used to collect sunlight for the purpose of stimulating a gain medium to produce an input laser for a PTG. The solar-pumped laser could then be inserted into the resonant cavities or waveguides of a PTG. For a given amount of solar radiation input, a solar-pumped PTG could produce significantly greater electricity than other forms of solar power.

While a solar-pumped PTG located on Earth would likely operate only during daylight hours, the amount of power generated could be so large that the surplus power from daytime operations could be stored and distributed at night. Given this high potential power output, PTG plants based in the Southwestern United States could conceivably provide a considerable fraction of the total power generated in the United States. Surplus power could be transmitted to regions of the country less well suited to solar-pumped PTG power plants.

While the direct applications of a solar-pumped PTG may be less numerous than the self-pumped PTG (e.g., vehicles, electronic devices), the vast amount of power supplied, with zero emissions, would provide significant benefits to individuals, businesses, and society. The power produced by solar-pumped PTGs could have a substantial effect on world energy production and may significantly reduce or eliminate dependence on fossil fuels and other limited resources that may be associated with detrimental effects to the environment.

The PTG could provide a virtually endless supply of clean power for a diverse range of applications, including power plants, transportation systems, industrial equipment, electrical devices, microscopic and nanoscopic systems or devices, and numerous other entities. While the PTG can be manufactured and operated using current, state-of-the-art optical materials, ongoing advances in optics and materials science—particularly the increased reflectivity of mirrors and reflective surfaces—could lead to even greater efficiency and power density in future PTGs.

These and other purposes, goals and advantages of the present application will become apparent from the following detailed description of example embodiments read in connection with the accompanying drawings.

### BRIEF DESCRIPTION OF THE DRAWINGS

Some embodiments of the present disclosure are illustrated by way of example and not limitation in the figures of the accompanying drawings, in which like reference numerals refer to like structures across the several views, and wherein:

FIG. 1 is a cross-sectional view of a Photon Turbine Generator (PTG) comprising a folded resonant cavity and having a gain medium located on the PTG but outside of the cavity, called herein a passive cavity;

FIG. 2 is a perspective view of the photon turbine and rotor sections of the PTG shown in FIG. 1, shown in cutaway view;

FIG. 3 is a cross-sectional view of a PTG comprising a folded resonant cavity and having a gain medium located on the PTG and inside the cavity, called herein an active cavity;

FIG. 4 is a cross-sectional view of a PTG comprising a folded resonant cavity with no gain medium located on this PTG, there being an input laser beam inserted into the photon turbine through a waveguide on the periphery of the fairing;

FIG. 5a is a cross-sectional view of a PTG comprising two folded resonant cavities, and no gain medium located on this PTG, an input laser beam being inserted into the photon turbine through the shaft;

FIG. 5b is an overhead, cross-sectional view of the PTG depicted in FIG. 5a, showing an input laser beam entering the shaft and being inserted into the folded resonant cavities on either side of the shaft by a series of directional mirrors, this view having the top of the fairing cut away to reveal the resonant cavities and laser beam paths inside;

FIG. 6 is a schematic diagram showing the torques applied to the folded resonant cavity depicted for example in any of FIGS. 1-4;

FIG. 7a is a schematic overhead system view of a PTG having the gain medium mounted on the photon turbine;

FIG. 7b is a schematic overhead system view of a PTG where the gain medium is not mounted on the photon turbine, and the input laser beam is inserted into the shaft of the photon turbine;

FIG. 8 is a cross-sectional view of a PTG having two ring resonators;

FIG. 9 is a cross-sectional view of a PTG having four closed-loop waveguides;

FIG. 10 is a cross-sectional view of a PTG having a stationary cylindrical mirror that surrounds a rotating shaft containing four mirrors;

FIG. 11 is a perspective view of the photon turbine and other components of the PTG shown in FIG. 10, with the stationary cylindrical mirror cut away to reveal the shaft containing the four mirrors;

FIG. 12 is a partial section view of a resonator mirror radiating heat toward the fairing;

FIG. 13 is a cross-sectional view of a heat pipe that extends along the crossbeam of a photon turbine, running from the shaft to a resonator mirror positioned on the crossbeam;

FIG. 14 is a perspective view showing cooling conduits running along both sides of a resonator mirror in a photon turbine;

FIG. 15 is a side view of the fairing of a photon turbine being cooled by jets of cold air or gas; and

FIG. 16 is a side view of a power plant using a solar-pumped PTG.

### DETAILED DESCRIPTION

In the descriptions of the drawings and preferred embodiments, the term “photon turbine” is used to refer to the portion of the Photon Turbine Generator (PTG) that includes the resonant cavities or waveguides; any mechanisms, devices, or systems that support the resonators or waveguides; and the surrounding structure in which the resonant cavities or waveguides are located, such as the fairing and the components located inside of the fairing. The term Photon Turbine Generator, or PTG, comprises the photon turbine, the electrical generator coupled to the photon turbine, and any equipment that supports, regulates, or monitors the photon turbine or electrical generator.

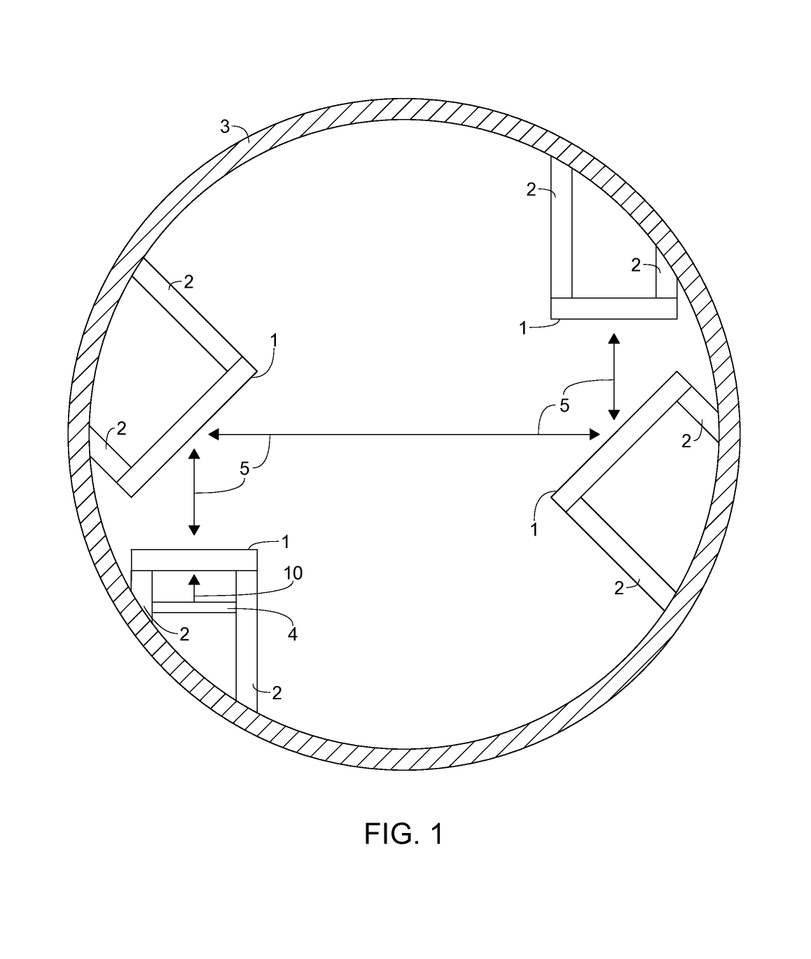

FIG. 1 shows a cross-sectional view of a Photon Turbine Generator (PTG) using a simple, Z-shaped, folded resonator design. Four mirrors 1 are supported on mounts 2 within a cylindrical structure 3, which will be subjected to torques in a manner broadly similar to a squirrel cage or hamster wheel. The force due to radiation pressure is applied to the mirrors, transmitted through the mirror mounts, and transferred to the fairing 3. All four mirrors 1 have the maximum possible reflectivity (>99.9999%) for the wavelength of the laser used in the PTG, thereby forming a power enhancement cavity. Cavity as used herein simply refers to the space that defines the reflected photon beam. It may be an open cavity or a closed cavity. Though reflection is disclosed as the primary means of directing photon energy throughout the present description, it will be appreciated by those skilled in the art that any method may be used to direct or guide the laser or EM radiation, including but not limited to reflection, total internal reflection, refraction, and diffraction or the like.

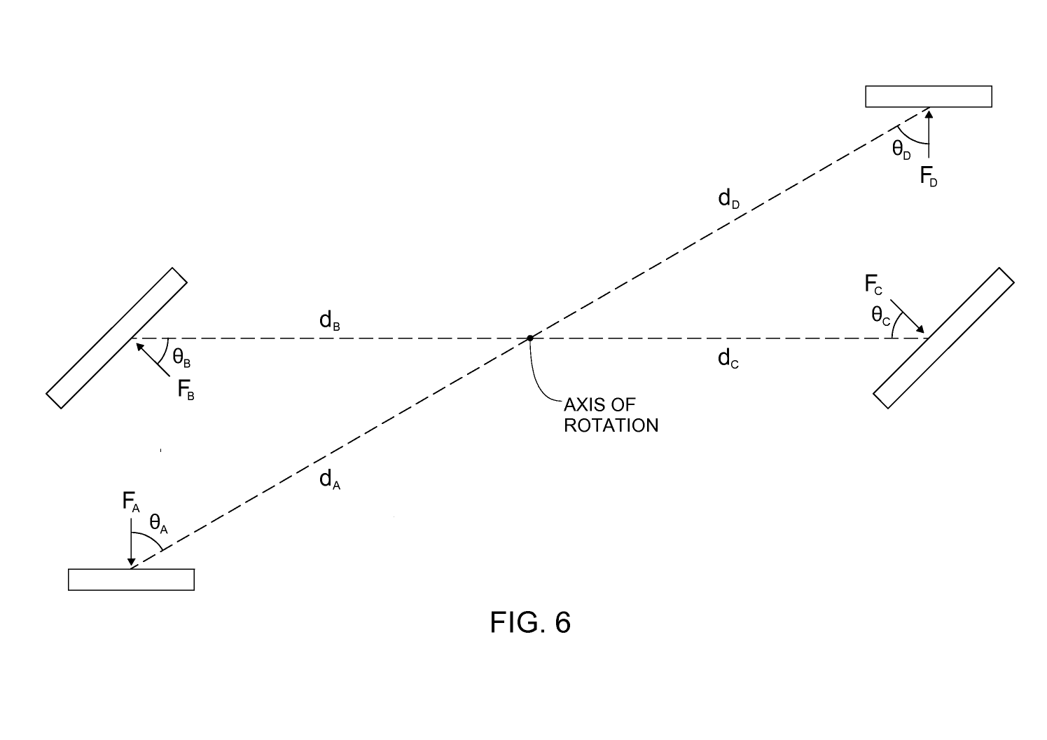

The laser generator 4 is located behind one of the mirrors of the resonant cavity. The laser generator 4 may use electrical, optical, or other means to stimulate the gain medium and produce the input laser beam 10. The mirror mounts, or a separate support structure, may be used to hold the laser generator 4 securely in place. The circulating laser beam 5 travels back and forth between the four mirrors, retracing the same path over and over again. In this folded cavity, the laser beam strikes the end mirrors 1 perpendicularly, while reflecting off the other two mirrors 1 at a 45 degree angle of incidence. The net torque applied by the forces due to radiation pressure causes the photon turbine to rotate. (Please see FIG. 6 and the sample mathematical equation in this specification for a detailed discussion of the torques produced in this resonator design.) The axis of rotation (not shown in this view) is halfway between the two mirrors shown at 45 degree angles.

Broadly speaking, the resonator itself forms the foundation of the photon turbine. This cross-sectional view features the resonant cavity and surrounding fairing 3. For simplicity, and to keep the focus on the core structure of the PTG, various components that may support the resonant cavity, such as mode-matching optical devices and piezoelectric transducers, are not shown. These supportive devices may be mounted on the photon turbine as needed for optimal performance and operation of the resonant cavity. In this figure, and in most of the figures in this specification, a single line with arrowheads is shown to depict a laser beam. However, in practice, the laser beam diameter (whether the laser is composed of a single beam or an array of beams) should be as large as possible, utilizing the available mirror surface area to the fullest extent. By applying the laser beams to the maximum possible surface area of the mirrors 1, the force applied to the mirrors 1 from radiation pressure may be maximized, thereby increasing the torque of the PTG. For simplicity and ease of explanation, only one resonant cavity is shown mounted on the photon turbine in FIG. 1. However, additional resonant cavities could be mounted on the photon turbine, thereby providing increased total torque.

The resonant cavities or resonators may be designed with various confinement conditions and may comprise various geometries, various beam path lengths, various numbers of mirrors or reflective surfaces, and various types of mirrors or reflective surfaces. The resonator may comprise bulk optical components, waveguides, or both. The resonator may comprise a light path traveling through free space, a waveguide, or both. The resonator may be open or closed. Furthermore, while this specification discusses resonators in which a vacuum or partial vacuum exists between the mirrors or reflective surfaces, it is possible for the laser beam to travel through other entities, such as air, glass, water, or other transparent liquids, solids, gases, or other materials. As example only, and without limitation, the cavity geometry may include any of a stable, unstable, unidirectional, bidirectional, multidirectional, a ring resonator or resonant cavity, a traveling wave resonator or resonant cavity, a standing wave resonator or resonant cavity, a plane-parallel resonator or resonant cavity, a linear resonator or resonant cavity, a Fabry-Perot resonator or resonant cavity, a folded resonator or resonant cavity, a telescopic laser resonator, a fiber ring resonator, an integrated pile ring resonator, an integrated-optic ring resonator, a microcavity, a microdisk, a microtoroid, a microsphere, a micropillar, a micropost, a resonator based on a defect in a photonic crystal, a near grazing resonator, a whispering gallery resonator, a circular resonator, an annular Bragg reflector, a one-dimensional resonator or resonant cavity, a two-dimensional resonator or resonant cavity, a three-dimensional resonator or resonant cavity, a symmetric resonator, a mirrorless resonator, a roof resonator, a distributed-feedback resonator, an optical oscillator, an optical parametric oscillator, a multi-prism grating laser oscillator, a planar ring oscillator, a nonplanar ring oscillator, a confocal resonator, a concentric resonator, a concave-convex resonator, a conjugate resonator, a spherical resonator, a hemispherical resonator, a long-radius hemispherical resonator, a large-radius hemispherical resonator, a plane parallel resonator, a long-radius resonator, a bowtie resonator, a planar waveguide, a rectangular waveguide, a linear waveguide, a fiber waveguide, a hollow silica waveguide, a power enhancement cavity, a power recycling cavity, a laser supercavity, or a supercavity.

Note that in FIG. 1, the mirrors are depicted as planar. This was done for simplicity in the presentation of the torque diagram in FIG. 6 and in the sample mathematical calculation. In practice, one or more of the mirrors in the resonant cavity would most likely be curved (e.g., spherical mirrors, long-radius mirrors, or large-radius mirrors) to help ensure the stability of the resonant cavity. In other figures in this specification, some of the mirrors shown are curved. This is mainly intended to help show a variety of possible designs. Those skilled in the art of resonator design may use whatever types of mirrors they consider to be appropriate for optimal performance and stability of the resonant cavity. The number of potential mirror combinations (e.g., spherical, long-radius, large-radius, planar) is likely just as varied as the number of potential resonator geometries (e.g., folded cavity, ring cavity, closed-loop waveguide) that may be used in the PTG. Any shape of mirror or reflective surface may be used in the resonator, resonant cavity, or waveguide, including but not limited to planar, near-planar, long-radius, large-radius, plano-concave, plano-convex, concave, convex, spherical, parabolic, elliptical, conical, and polygonal designs.

One important note regarding mirror curvatures: Because the force of radiation pressure is substantially higher for a perpendicular reflection compared with an oblique reflection, a planar mirror will experience a greater force than a curved mirror when reflecting a laser beam of the same intensity at a perpendicular or normal angle of incidence. This is because the entire surface of the planar mirror receives the laser beam at a perpendicular angle of incidence, whereas with a curved mirror, only a small area on the principal axis would reflect the laser beam at a perpendicular angle of incidence, while the rest of the beam would reflect from the mirror at oblique angles. These oblique angles could be small or large, depending on the radius of curvature of the mirror and the precise location of the reflection of a photon off the mirror. Thus, when designing resonators for the PTG, it may be preferable to use planar mirrors to receive perpendicular reflections. This way, the force of radiation pressure applied in a perpendicular reflection can be maximized, which may help to create the imbalance of torques that causes the rotation of the PTG.

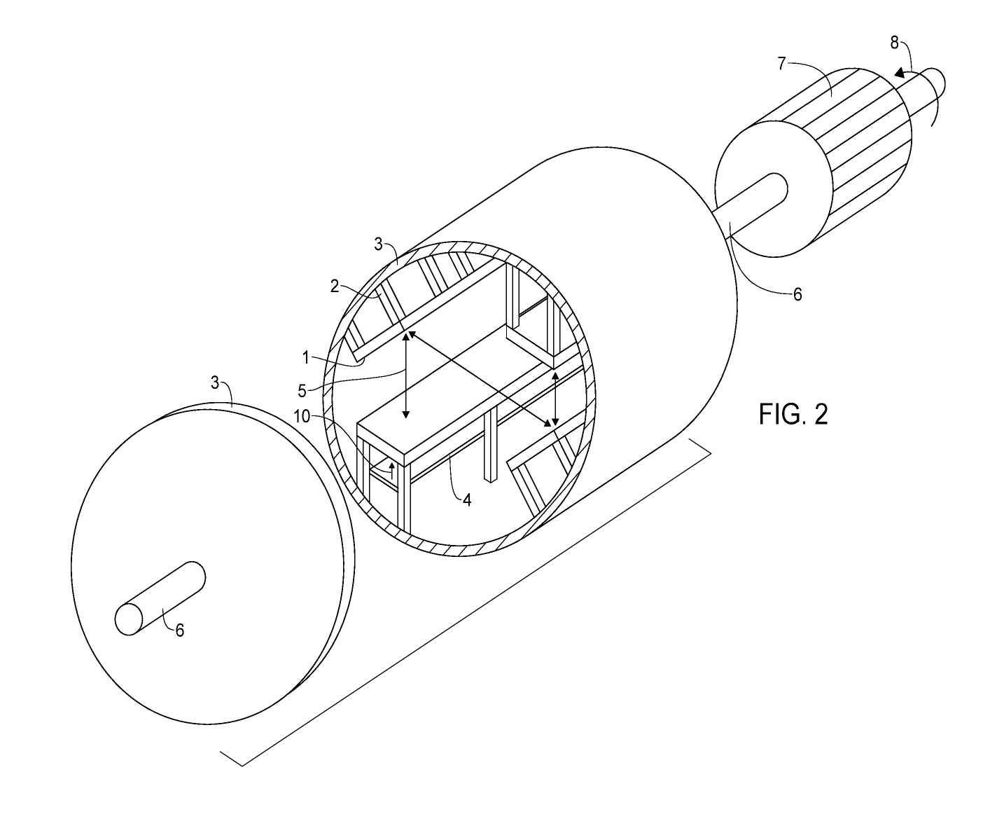

FIG. 2 shows a perspective view of FIG. 1. The mirrors 1 extend longitudinally through the cylindrical fairing 3, running along the axis of rotation. The laser generator 4 also extends throughout the fairing, directly behind one of the mirrors 1. At the ends of the fairing 3, a central shaft 6 extends in both directions. A conventional rotor 7, which in this particular configuration contains the field windings 7, is shown on the shaft 6 to the right of the photon turbine. The laser generator 4 produces the input laser beam 10, which is inserted into the resonant cavity to form the circulating laser beam 5. When the resonant cavities are established, the imbalance of torques applied to the mirrors 1 will cause the PTG to rotate in a counterclockwise direction 8. The force of the radiation pressure on the mirrors of the resonant cavity is transferred through the mirror mounts 2 to the fairing 3, which will rotate based on the net torque applied to it.

In this drawing, and throughout this specification, a cylindrical fairing 3 is used to contain the resonators. This is merely one type of containment vessel. Numerous other types or shapes of fairings or enclosures might be selected to contain one or more resonators. Alternately, the PTG could be designed without a fairing and the resonator mirrors could apply torque to the shaft by another method, e.g. attaching the mirror mounts directly to the shaft. The cylinder is used in this specification for its simplicity and relatively good aerodynamic properties. The cylindrical fairing 3 in this figure would rotate on the same shaft 6 with the rotor field windings 7. The fairing 3 is shown here with hatching for simplicity and to convey that this structure must be able to withstand significant forces that are applied to it. However, the fairing 3 does not have to be an entirely solid structure. Instead, it may contain passages for electrical wiring or other components that support the PTG. Any shape of fairing may be used, including but not limited to cylinders, spheres, spheroids, ovoids, toroids, and rings.

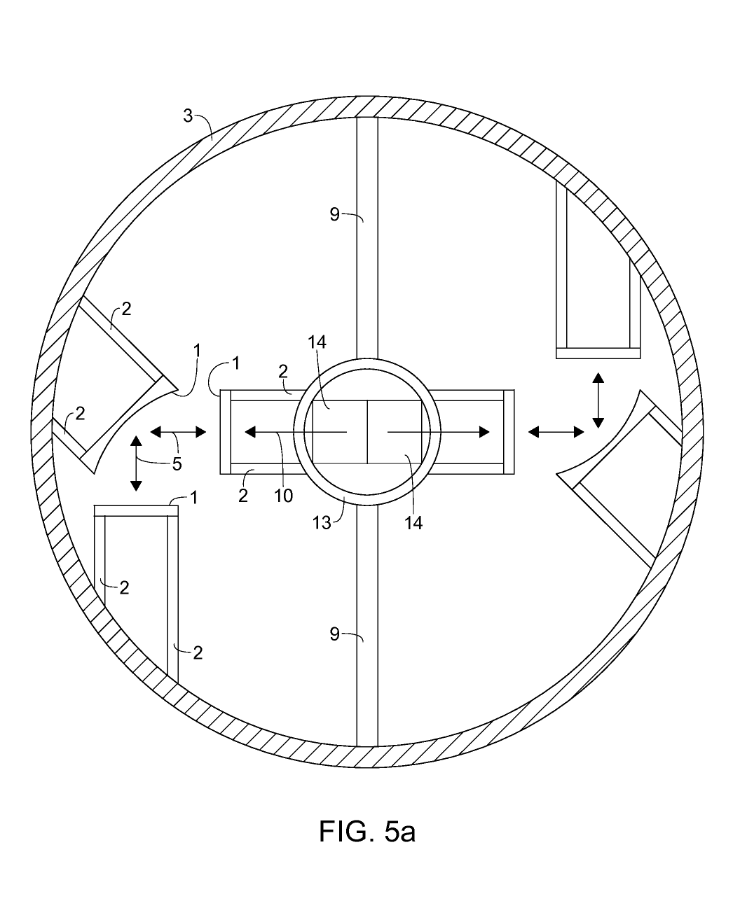

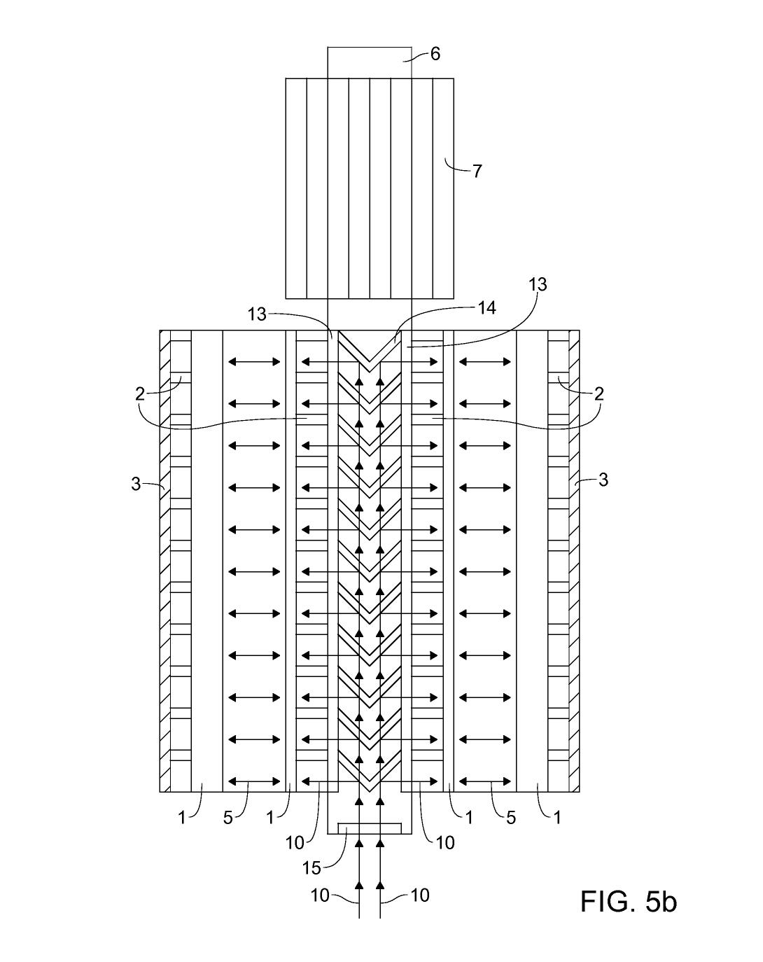

While the resonator geometry shown in FIG. 1 is depicted inside the fairing 3 in FIG. 2, the fairing 3 could be used to contain various resonator geometries. The resonator geometries shown in FIGS. 5a, 8, and 9 could also be extended through a cylindrical fairing. One or more resonators may be mounted inside of the fairing 3 to produce either clockwise or counterclockwise rotation 8.

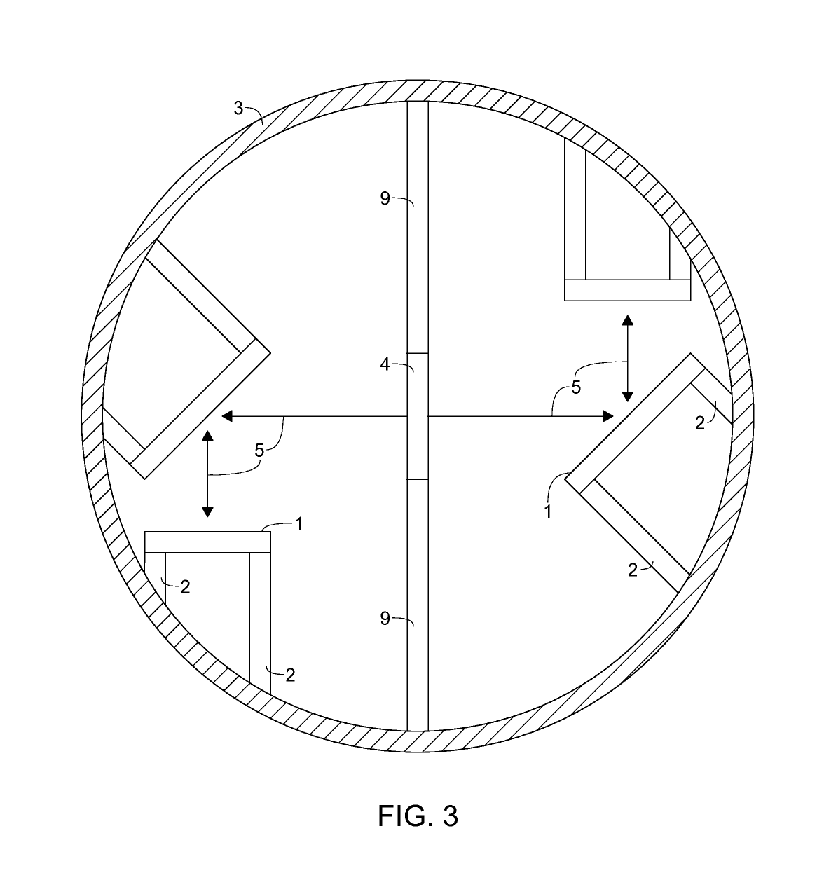

FIG. 3 shows a PTG with the laser generator 4 placed at the center of the resonant cavity. Alternately, the laser generator 4 could be mounted directly in front of one of the mirrors or any other place inside the resonant cavity. In this PTG design, the laser generator 4 extends along the axis of rotation inside the cylindrical fairing 3. A crossbeam 9 holds the laser generator 4 securely in place and may also contain or support electrical wiring, electrodes, diodes, or other means to stimulate the gain medium. The crossbeam 9 may also contain a heat transfer mechanism to help reduce the thermal stress on the gain medium.

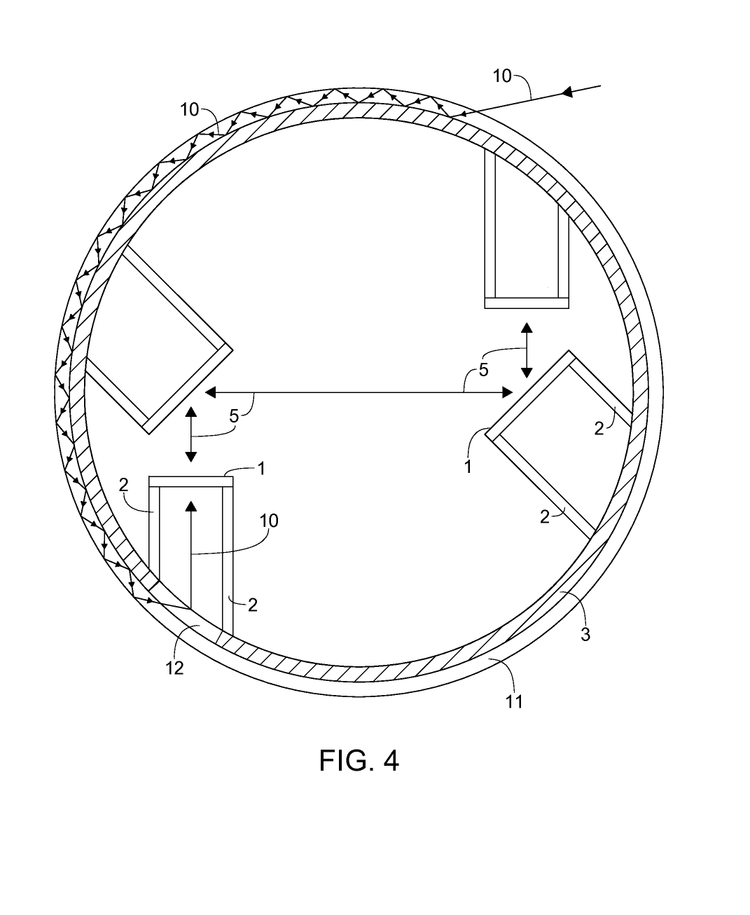

FIG. 4 shows a PTG using the same mirror geometry as the PTGs in FIGS. 1-3. However, the laser generator (not shown) is not located on the PTG in FIG. 4. Rather than being mounted on the PTG, the laser generator is placed at a separate, stationary location. Thus, a method for inserting the input laser beam 10 into the PTG is also shown. The input laser beam 10 produced at a separate location enters the photon turbine through a transparent outer wall 11 that is part of a waveguide attached to the cylindrical fairing 3. The input laser beam 10 then travels inside the waveguide 11 that runs along the outer edge of the fairing 3. The input laser beam 10 eventually enters a collimator 12 positioned behind one of the mirrors of the resonant cavity. The collimator 12 adjusts the direction of the laser beam so that it is inserted into the resonant cavity at the appropriate angle. With this method, the resonator can be continuously supplied with an input laser beam 10. Note that additional optical components may be placed between the collimator and the back side of the input mirror of the resonant cavity to facilitate operation of the resonant cavity. Any method of inserting, injecting, coupling, locking, or directing the laser or EM radiation into the resonant cavity or waveguide may be used, including but not limited to mode matching, impedance matching, photon tunneling, coupling prisms, lens coupling, grating coupling, diffractive coupling, direct coupling, air gap coupling, vacuum gap coupling, prism coupling, prism-film coupling, polarization coupling, nonlinear coupling, phase matching, evanescent coupling, coupling through the back of any mirror or reflective surface, deflection coupling, directional coupling, hole coupling, transmission coupling, multi-mode coupling, direct fiber coupling, energy coupling, near-field coupling, optical waveguide coupling, transition coupling, transitional coupling, dispersive coupling, lateral coupling, back coupling, edge coupling, plasmonic coupling, interference coupling, mesh coupling, cross coupling, double coupling, phase-generating coupling, side locking, dither locking, and the Pound-Drever-Hall method. Furthermore, any number of beams of EM radiation may be coupled by any method into any number of resonators, resonant cavities, or waveguides.

The waveguide 11, which encircles the cylindrical fairing 3, is rotationally symmetrical. The waveguide 11 would extend along the entire length of the cylindrical fairing 3, forming an outer cylinder around it. Thus, as the PTG rotates, the input laser beam 10 may be constantly inserted into the waveguide 11, where it will bounce between the walls and eventually reach the collimator 12, which it will pass through before entering the resonator. Various other methods of inserting the input laser 10 into the resonant cavity of the PTG may be designed (one of which is discussed in this specification). This is only one example that might be useful for PTG designs in which the central shaft 6 does not run through the interior of the fairing 3. Waveguides of any type, including but not limited to planar, rectangular, linear, or fiber waveguides, may be used wherever the present disclosure calls for the use of waveguides.

Regardless of which method of insertion is used, it is important that the input laser beam 10 is applied continually to the resonator. If the resonator only receives intermittent power from the input laser beam 10, this will reduce the amount of torque applied to the PTG. Continual input power may be provided by either a pulsed laser or a continuous wave laser. The laser or EM radiation used may be of any type, including but not limited to continuous wave, intermittent, pulsed, polarized, linearly polarized, circularly polarized, elliptically polarized, transversely polarized, plane polarized, or non-polarized. The laser or EM radiation used is based on any mode of operation, including but not limited to transverse modes, longitudinal modes, single modes, multiple modes or multi-modes, parasitic modes, off-axis modes, degenerate modes, lower-order modes, higher-order modes, fundamental modes, Gaussian modes, Hermite-Gaussian modes, Laguerre-Gaussian modes, and Bessel modes. The laser or EM radiation may be single-frequency, mode-locked, monochromatic, nonmonochromatic, plane wave, non plane wave, or may involve paraxial propagation. Any beam quality, spectral brightness, spectral width, frequency spacing, or spatial distribution may be used. Any presently known method, technique, or equipment may be used to establish or maintain the quality, direction, or performance of the laser or EM radiation, including but not limited to optical isolators, optical diodes, collimating lenses, collimators, mode-matching optical components, piezoelectric transducers, piezo-controlled mirror actuators, and servo-controllers. Whichever type of laser is used, it is advantageous to continually feed the photon turbine 16 with the input laser beam 10, so that a constant torque, and therefore a constant power output, is maintained.

FIG. 5a shows a PTG design that uses an alternate method for inserting the input laser beam 10. This method involves inserting the input laser beam 10 into the end of the shaft 6, which extends through the fairing 3. Because the shaft runs through the center of the fairing 3, the resonator geometry of FIG. 1 has been modified. The PTG shown in FIG. 5a comprises two resonant cavities—one on either side of the shaft 6. Note that the two resonator mirrors 1 closest to the shaft 6 do not produce any torque, because the force of radiation pressure is applied directly along the lever arm.

Part or all of the rim of the shaft 6 is transparent 13 to allow the input laser beam 10 to exit the shaft and enter the resonant cavities. A series of mirrors 14 making a 45 degree angle to the axis of rotation (and 90 degree angles with each other) are positioned inside the shaft 6. All of the mirrors 14 in the series are semi-transparent, except for the last pairing, which have a high reflectivity.

As shown in FIG. 5b, the input laser beam 10 is inserted into the end of the shaft 6 through a window 15. Instead of using a window, the shaft 6 could simply be left open or uncovered to allow the input laser beam 10 inside. After entering the shaft, the input laser beam 10 is distributed into the resonant cavities by a series of semi-transparent directional mirrors 14. Because the resonant cavities extend throughout nearly the entire length of the fairing 3, the input laser beam 10 is inserted into the cavities incrementally, ensuring that each section of each resonant cavity receives an appropriate amount of the input laser beam 10. The directional mirrors 14, which are positioned in the shaft in V-shaped pairings 14, can be provided with the precise degree of reflectivity to allow for the proper distribution of the input laser beam 10 throughout the resonant cavities. Because the shaft 6 rotates in unison with the resonant cavities on either side of it, the series of semi-transparent directional mirrors 14 will remain properly aligned to insert the input laser beam 10 into the resonant cavities during rotation of the PTG. Note that additional optical components may be placed between the shaft and the back side of the input mirrors of the resonant cavities to facilitate operation of the resonant cavities.

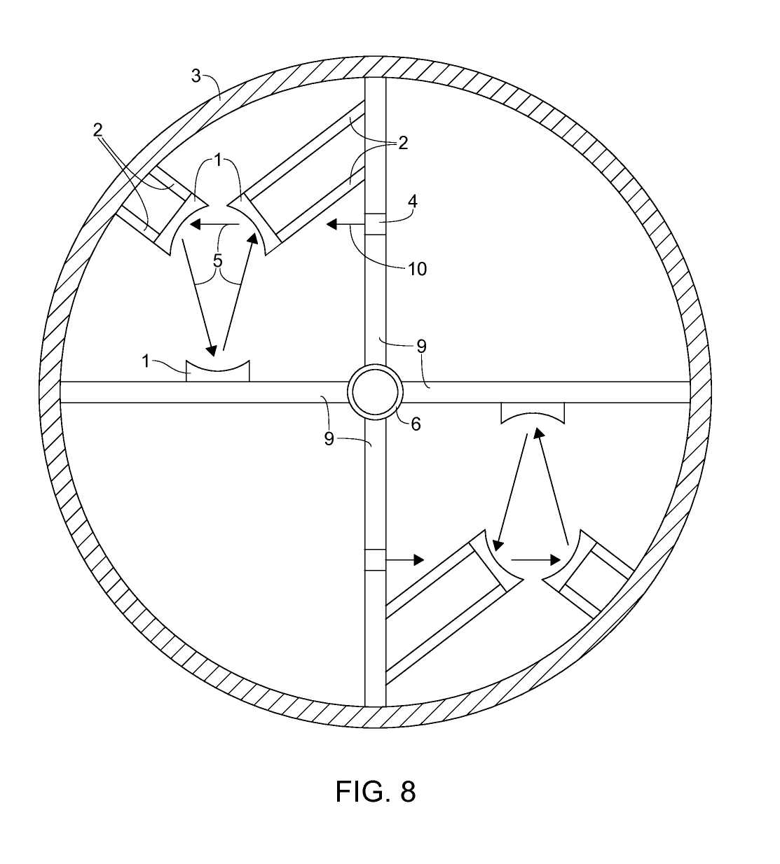

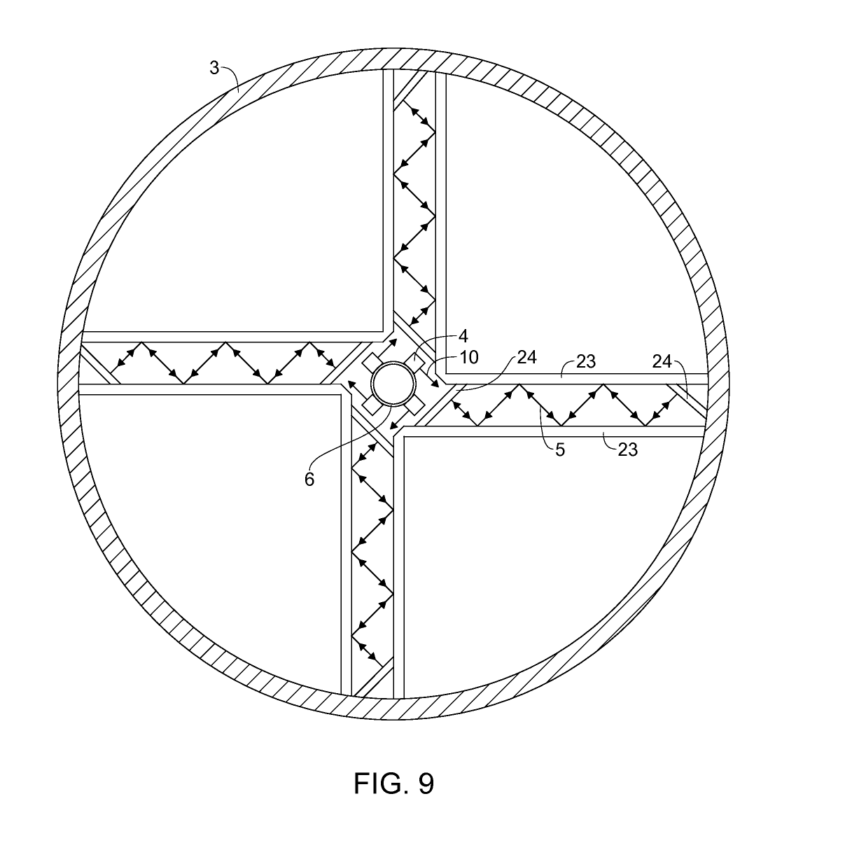

This method of inserting the input laser beam 10 could be used for many different resonator configurations. Once the input laser beam 10 is traveling through the shaft 6, one or more directional mirrors 14, can be used to guide the input laser beam 10 into the resonant cavities or waveguides. This technique of inserting the laser beam into the shaft 6 could be applied to other PTG designs in this specification, including FIGS. 8 and 9. It could also be applied to many other types of resonator designs.

FIG. 6 schematically depicts the forces acting on the mirrors due to radiation pressure of the laser beam circulating inside the resonant cavity shown in FIGS. 1-4. Based on the different angles of incidence, different angles made by the forces with their lever arms, and different distances of the mirrors from the axis of rotation, an imbalance of torques will cause the PTG to rotate. With this particular design, the PTG will rotate in a counterclockwise direction.

The following sample equation uses this resonator design to show the net torque acting on the photon turbine and highlights the potential of the PTG for extremely high efficiency. Once the power of a circulating laser beam is determined, the three main variables to consider in the design of a resonator for a PTG are: (1) the angle of incidence of the circulating laser beam on each mirror or reflective surface; (2) the angle that each mirror makes with the lever arm; (3) and the length of the lever arm for each mirror.

Now let's examine the potential power output and efficiency of the PTG shown in FIGS. 1 and 2 with a sample calculation. In FIG. 6, from the lower left to the upper right, the mirrors are indicated as A, B, C, and D.

Let's assume that all four mirrors have a reflectivity of 99.99999%. This will enable the average photon to make 10 million bounces before escaping the resonator. In this resonator, one round trip involves 6 bounces off of the mirrors. Therefore, the power enhancement inside of the cavity is 10 million/6=1.67 million.

Thus, an input laser beam of 1 kW would result in a circulating laser beam of 1.67 GW. The force applied by radiation pressure to a perpendicular reflective surface is 2 P/c. (While this is the theoretical maximum amount of force from radiation pressure based on a perfectly reflecting surface, the extremely high reflectivity of the multilayer dielectric mirrors allows the use of this equation with negligible deviations).

The force from radiation pressure on an oblique reflective surface is 2 P(cos²θ)/c. Thus, the forces acting on the mirrors are as follows:

F_{A}=2(1.67×10⁹ W)/2.998×10⁸ m/s=11.14 N

F_{B}=2(1.67×10⁹ W)(cos 45°)²/2.998×10⁸ m/s=5.57 N

F_{C}=2(1.67×10⁹ W)(cos 45°)²/2.998×10⁸ m/s=5.57 N

F_{D}=2(1.67×10⁹ W)/2.998×10⁸ m/s=11.14 N

For simplicity, let's assume that the center points of the two mirrors on each side of the axis of rotation form 30-60-90 triangles with the axis of rotation. Also, let's assume familiar ratios and units. So the sides of each triangle are: 1 m, 1.732 m, and 2 m. Thus the distance from the axis of rotation to mirrors B and C is the square root of 3, or 1.732 meters. The distance from the axis of rotation to mirrors A and D is 2 meters.

Because the force due to radiation pressure is always perpendicular to the reflective surface, the forces on the mirrors will make the following angles with their respective lever arms:

θ_{A}=60°

θ_{B}=45°

θ_{C}=45°

θ_{D}=60°

Now that we have the forces, distances, and angles made with the lever arms, the torque can be calculated for each mirror as follows:

τ_{A}=F_{A}(sin θ_{A})d_{A}=11.14 N(0.866)(2 m)=19.29 Nm(counterclockwise)

τ_{B}=F_{B}(sin θ_{B})d_{B}=5.57 N(0.707)(1.732 m)=6.82 Nm(clockwise)

τ_{C}=F_{C}(sin θ_{C})d_{C}=11.14 N(0.707)(1.732 m)=6.82 Nm(clockwise)

τ_{D}=F_{D}(sin θ_{D})d_{D}=11.14 N(0.866)(2 m)=19.29 Nm(counterclockwise)

Thus, the net torque can be calculated by adding the torques:

Counterclockwise=19.29 Nm+19.29 Nm=38.58 Nm

Clockwise=6.82 Nm+6.82 Nm=13.64 Nm

38.58 Nm−13.64 Nm=24.94 Nm counterclockwise

Now that the net torque has been calculated, the power output of the generator can be determined. Let's assume that the PTG rotates at 3600 rpm. This equates to 60 RPS. Thus, the angular velocity is:

ω=2π(RPS)=2π(60)=377 rad/s

Thus, the power output of the PTG is:

τ×ω=24.94 Nm×377 rad/s=9,402 W=9.4 kW

This power output is significantly greater than the 1 kW of the input laser beam. If we assume that the input laser beam has a wall-plug efficiency of 50%, then it would need 2 kW to operate. The power output of the PTG can provide this power, and have significant power (7.74 kW) remaining to provide to various applications.

Power Output−Power Input=9.4 kW−2 kW=7.4 kW

While an onboard feedback control system would require some power, and there may be minor windage losses, these factors would not significantly affect the extremely high efficiency of the PTG. The efficiency of the PTG is:

9.4 kW/2 kW=4.7=470%

The size of the mirror that could accommodate a 1.67 GW circulating laser beam, assuming an optical damage threshold of 100 MW/cm² continuous wave, would be 16.7 cm²—about the size of a large coin. If this PTG were scaled up to the size of a large steam turbine, with mirrors that were 20 m×2 m (extending along the shaft, as in FIG. 2), the total surface area would be 400,000 cm². Assuming the same rotational speed (3600 rpm), the scaled-up PTG would produce 225 MW, based on the increased torque. Thus, the PTG can produce both efficient power and large quantities of power when scaled up.

Mirrors with reflectivity >99.9999% are currently marketed by specialty optics companies. Ultrahigh reflectance mirrors are used for a variety of applications, including cavity ringdown spectroscopy, gravitational wave detection, and ring laser gyroscopes. The expertise of manufacturers who provide extremely high reflectance mirrors for these fields could be utilized in the construction of a PTG. Thus, for the purposes of the previous sample calculation, reflectivity of 99.99999% was assumed. However, the PTG would still be a useful invention even with mirror reflectivity of 99.9999% or lower. With lower mirror reflectivity, the likelihood of achieving overunity efficiency decreases, and therefore solar pumping of the input laser beam, rather than self-pumping, would likely be the most effective method of operating the PTG. However, to demonstrate the full potential and optimal manifestation of the PTG, the inventor has used the highest reflectivity that he has seen discussed in legitimate sources.

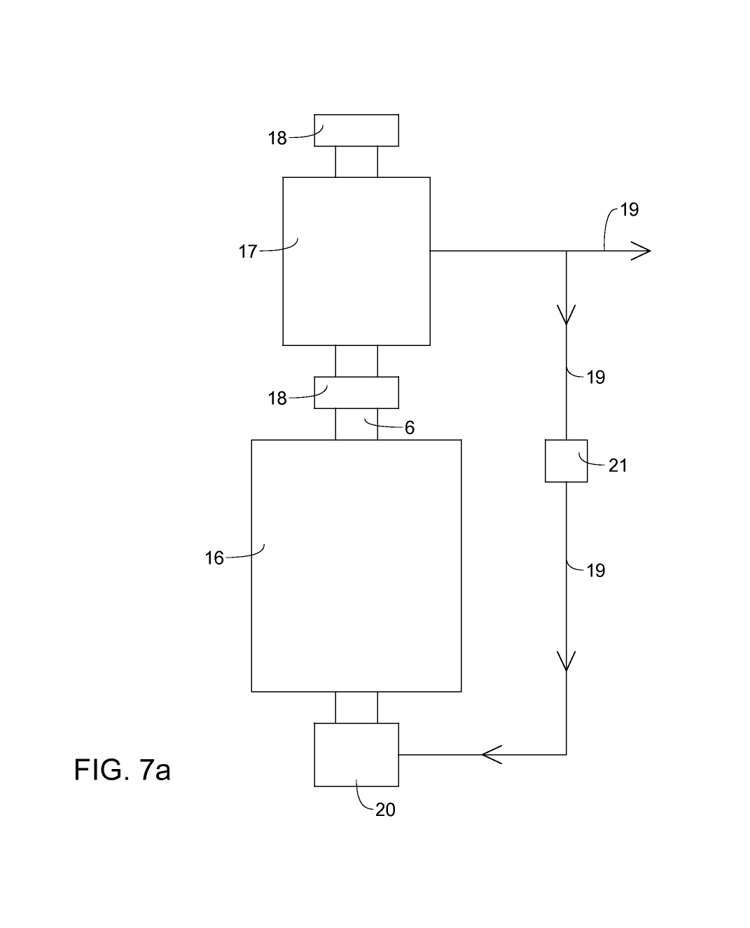

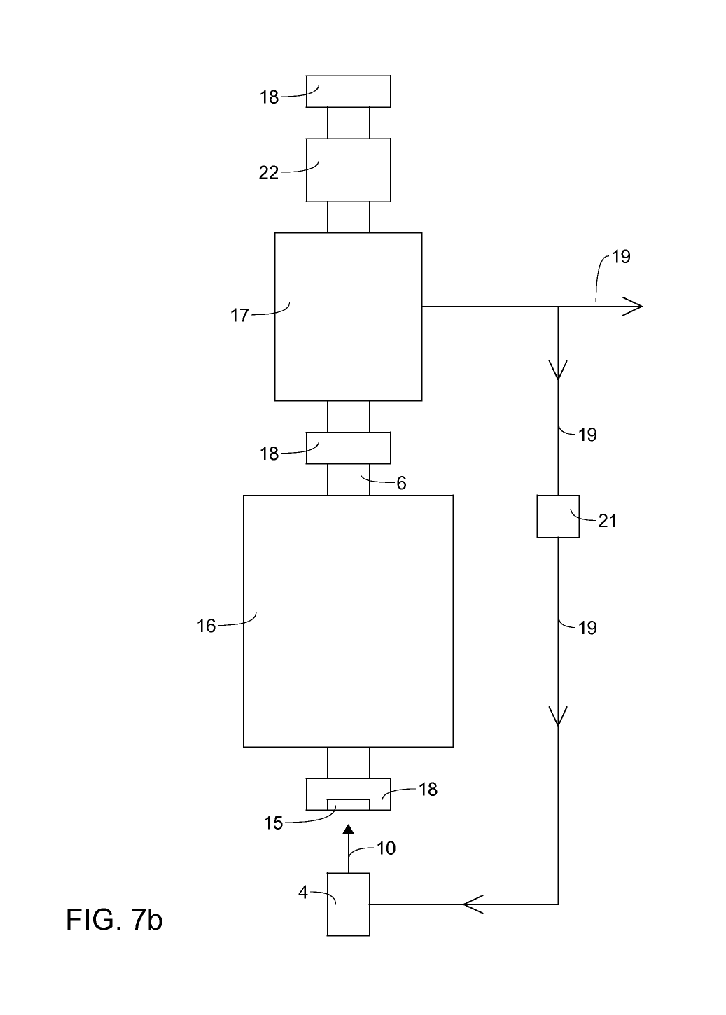

FIG. 7a shows an overhead view of a PTG with the laser generator (or laser generators) located inside the photon turbine 16. The resonant cavities or waveguides are located inside of the cylindrical fairing. The fairing provides a sealed container that may serve as a vacuum enclosure for the resonant cavities or waveguides. By evacuating the space (or portions of the space) inside of the fairing, an environment can be created to enable maximum power enhancement within the resonant cavities or waveguides. In addition to serving as a vacuum enclosure, the fairing provides an aerodynamic shell to allow for efficient high-speed rotation. The fairing contains the mirrors or reflective surfaces, mirror mounts, and electrical wiring, electrodes, diodes, or other equipment used to stimulate the gain media. It may also contain heat transfer mechanisms to help cool the mirrors or reflective surfaces, gain media, and other components. Electrical wiring in the fairing may also provide electricity to optical or electrical components, such as PZTs or piezo-controlled mirror actuators which may be used to enhance or facilitate operation of the resonant cavities. The electrical wiring could run within or along the shaft, or along any structural components, such as crossbeams or mirror mounts. Electrical power may be provided to the photon turbine 16 using conventional means, such as slip ring assemblies or rotary transformers.

In addition to the photon turbine 16, the PTG also includes conventional power generation equipment 17, including a rotor and stator. Bearing assemblies 18 are positioned to support the shaft 6. Conventional mechanical bearings may be used for the PTG. For smaller-sized PTGs that may operate at high rotational speeds, magnetic bearings (potentially with mechanical backup bearings) might be useful for supporting the shaft. Any type of bearing system may be used however, including but not limited to mechanical bearings in either a primary or backup capacity, magnetic bearings, active magnetic bearings, passive magnetic bearings, liquid bearings, fluid bearings, solid bearings, ceramic bearings, air bearings, and gas bearings.

The initial start-up power for the PTG may be provided by an existing power supply. However, once the PTG has reached its operating speed, it can produce enough power such that a percentage of its output may be diverted to provide electricity to stimulate the gain medium. Thus, the PTG would be “self-pumped.” A self-pumped PTG would be capable of operating continuously for a long period of time—potentially for many years. The main limiting factor would be the lifetime of the laser. This is why diode lasers are an attractive option for the PTG. Diode lasers may have lifetimes that allow for over 100,000 hours of continuous operation. Other limiting factors for the PTG are the normal wear and tear of the electrical and mechanical equipment. Thus, the PTG is not a perpetual motion machine. Nor does it violate the Second Law of Thermodynamics. Its potential for greater than 100% efficiency is a feature that has a limited duration—specifically, the lifetime of the gain medium and/or laser pumping devices. However, these components may be reused after they degrade or expire. For example, the crystals of diode lasers or diode-pumped solid-state lasers could be recycled and re-fabricated for future use in a PTG.

As shown in FIG. 7a, some of the electrical output 19 from the stator is distributed to the application that the PTG is supplying power to (e.g., the electrical power grid, a vehicle, an electronic device). The remainder of the electrical output is distributed back onto the photon turbine to pump the input laser and provide power to other components, such as a feedback control system or heat removal system.

Wiring runs from the stator 17 to a PTG control center 21, which distributes electricity onto the photon turbine 16 through the bearing and power transfer assembly 20. In addition to supplying the PTG with electricity to maintain operation of the resonant cavities or waveguides, the control center may be used to manage a feedback control system for optimal performance of the resonant cavities or waveguides, regulate a heat removal system, monitor the performance of various components onboard the photon turbine 16, and oversee a safety system in which automatic shutdown of the input laser beam would be implemented under certain conditions (e.g., mirror misalignment, mirror damage, bearing failure, breach of the fairing by a foreign object). The primary responsibility of the control center is to control the power of the input laser. By adjusting the power of the input laser, the amount of circulating power inside the resonator can be controlled. The control center 21 can determine the appropriate amount of laser pump power based on the electrical load placed on the PTG. Thus, the PTG allows for precision control of torque through the control of the power of the input laser beam. Precision control of torque is another advantage of the PTG over many existing electrical generators. To adjust the torque, the input laser beam may be adjusted in power, or even turned off temporarily. This will modify the power of circulating laser beam and therefore the torque with a nearly immediate response time. If a PTG has no electrical load placed on it (e.g., a computer, power tool, or vehicle that a PTG provides power to is not being used), the control center 21 may reduce the power of the input laser beam, or turn off the input laser beam periodically. Thus, the PTG could continue to spin at the normal operating speed—so that it will be prepared for a full electrical load when the device it is connected to is turned on—but usage of the laser generator would be minimized. The input laser beam would only need to provide enough power to enable the PTG to overcome any general countervailing forces, such as friction and air resistance, and maintain a constant angular speed. This is roughly analogous to the “sleep” or “standby” mode, such as implemented in a computer. By using only minimal power to keep the PTG spinning, the stress on the gain medium and pumping devices may be reduced and the laser lifetime increased. The control center 21 may also function as power conditioning equipment or a power management system operative to modify or adjust the electrical power output. The control center 21 may also be configured as a control mechanism to regulate the speed of the PTG, including but not limited to controlling the input laser, any type of braking system, or any method of applying counter-torque.

FIG. 7b shows an alternate configuration of the PTG in which the input laser beam 10 is not produced on the photon turbine 16. Rather, the input laser beam 10 is produced at a separate location and is then inserted into the photon turbine 16. This configuration removes the need to produce and manage the input laser beam while it is rotating on the PTG. However, it also requires a method of inserting the input laser beam into the photon turbine 16 while the PTG is rotating, in a manner that is capable of providing continual power (which may be provided by various types of lasers, including pulsed or continuous wave lasers) to the resonators. Two methods of inserting the input laser beam into the photon turbine 16 are discussed in FIGS. 4, 5a, and 5b. The shaft method of inserting the input laser beam is depicted in FIG. 7b.

This PTG configuration uses an exciter 22 instead of a slip ring assembly to provide electricity to the PTG. If the laser generator 4 is not located on the PTG, it significantly reduces the need for electrical power onboard the PTG. The feedback control system and potentially a heat removal system would require some power, but these systems might be supported by the electricity produced by the exciter 22.

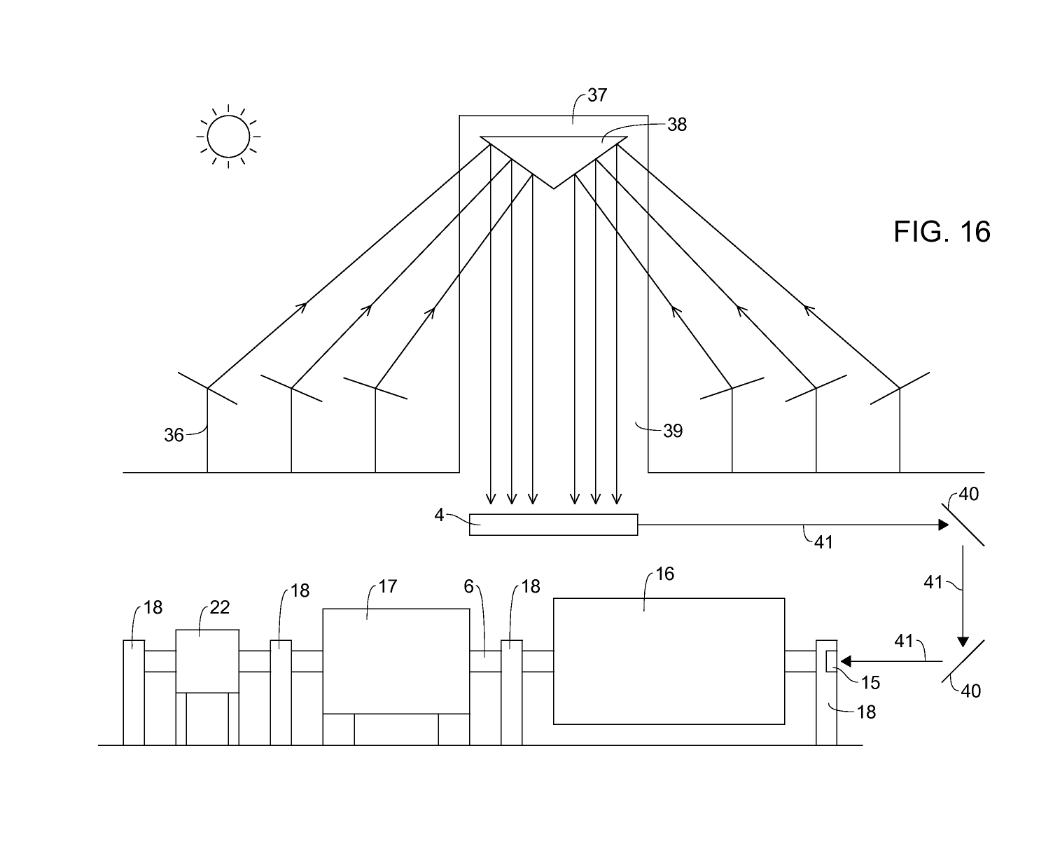

Thus, in this configuration, the exciter 22 produces electricity not only for the rotor field windings, but also for the feedback control system, potential heat removal system, and any other systems or components supporting the PTG. In this configuration, the control center 21 provides electrical power to the laser generator 4, which produces the input laser beam 10. In this figure, the input laser beam 10 is aimed at a laser window 15 at the end of the shaft 6. However, the input laser beam 10 may also be produced at a separate location, transmitted across an area using directional mirrors, and ultimately guided into the PTG, as shown in FIG. 16.

Various methods, including but not limited to a slip ring assembly, rotary transformer, or exciter could be used to provide electricity to the PTG. Any of these devices may be used with any configuration of the PTG. FIG. 7a uses a slip ring assembly because stimulating an onboard gain medium might require a substantial amount of electricity, depending on the size and efficiency of the PTG. If the gain medium is not placed on the photon turbine 16, the power requirements onboard the photon turbine will likely be substantially reduced, and the exciter may be a preferable option to provide onboard electricity.

FIG. 8 shows a cross-sectional view of a PTG using two ring resonators. This configuration shows that the PTG may be designed and operated with ring cavities. Laser generators 4 are placed on a crossbeam 9 near the resonant cavities. The laser generators 4 produce the input laser beams 10, which are inserted into the resonant cavities, thereby creating passive cavities. The triangular shaped resonators are pointed in opposite directions, so that their net torques are additive. Each resonator produces a net torque in a counterclockwise direction. Plural ring resonator cavities are arranged to be rotationally symmetrical around the longitudinal axis of the shaft 6.

The direction of the forces due to radiation pressure applied to the mirrors 1 farthest from the shaft 6 runs directly along the lever arms made between these mirrors and the axis of rotation 6. Thus, the torque provided by these mirrors is zero. Of the two remaining mirrors 1 within each resonant cavity, the mirrors 1 mounted on the crossbeams 9, which reflect the circulating laser beam 5 at a low angle of incidence, produce greater torque than the other mirrors 1. This is because of the lower angle of incidence of the circulating laser beam 5 and larger angle that the force makes with the lever arm compared with the other mirrors 1. The net torque on the photon turbine results in counterclockwise rotation of the PTG. Neutralizing one of the mirrors 1 in each resonator by ensuring the force applied to it is coincident with the lever arm is not necessary to create an imbalance of torques when using this PTG design. However, this technique was used in this figure to highlight a useful tactic when designing resonant cavities for the PTG. Positioning resonator mirrors 1 so that their forces extend directly along their lever arms, or placing mirrors directly adjacent to the axis of rotation 6, may be useful ways to reduce or eliminate the torque of one or more of the mirrors in the resonant cavities or waveguides, thereby helping to create the imbalance of torques necessary to rotate the PTG.

Using a mirror geometry based on a narrow isosceles triangle can help to create the imbalance of torques that results in rotation of the PTG. By using a narrow isosceles triangle, the angle of incidence on one of the mirrors is lower than the other two mirrors. This results in a significantly greater force from radiation pressure on the mirror that receives the circulating laser beam 5 at a low angle of incidence. Also, if the mirror with the lower angle of incidence is placed in line with the lever arm—as shown in FIG. 8 by mounting this mirror on a radial crossbeam 9—then the force will be applied perpendicularly to the lever arm. In contrast, the other mirrors may be positioned to create oblique angles with the lever arm, or be perpendicular to the lever arm. This further increases the difference in torque produced between the mirrors.

As with the Z-shaped folded PTG configuration, this configuration may include the gain medium either outside the resonators, resulting in passive cavities (as shown in FIG. 8), or inside the resonators, resulting in active cavities. A passive cavity would most likely involve a unidirectional circulating laser beam. An active cavity would involve a bidirectional circulating laser beam, unless an optical isolator or optical diode were used to produce a unidirectional circulating laser beam. Either a unidirectional or bidirectional circulating laser beam would provide counterclockwise rotation. Also, the laser generator 4 could be taken off this PTG and placed at a separate location. The input laser beam could then be inserted through the shaft (as shown in FIGS. 5b and 7b) or with another method and then distributed into the ring resonators. Similar to FIG. 2, the ring resonators would extend through the length of the cylindrical fairing. The laser generator 4, mounted on the crossbeams 9, would also extend through the length of the fairing.

FIG. 9 shows a PTG that uses closed-loop waveguides extending outward from the shaft 6. In the embodiment shown, the waveguides are straight and radial, though they may extend generally radially but not necessarily straight, for example in a spiral fashion or some other way, without departing from the scope of the present disclosure. Four waveguides are shown, though more or fewer may be included. The waveguides are arranged generally in a rotationally symmetric way around the axis of the shaft 6. The circulating laser beam 5 bounces back and forth inside the waveguides, striking the walls of the waveguides 23 with the same angle of incidence. The laser generators 4 are placed near the shaft 6, behind one of the end mirrors 24 of each waveguide. End mirrors 24 positioned at both ends of each waveguide keep the circulating laser beam 5 in the waveguide.

The circulating laser beam 5 applies the same amount of force due to radiation pressure against each wall. However the angle that the force makes with the axis of rotation 6 is different, depending on which wall is struck by the circulating laser beam 5. For example, in the waveguide that extends rightward from the shaft, when the laser beam reflects off the top wall, the force applied is perpendicular to the lever arm. In contrast, when the circulating laser beam 5 reflects off the bottom wall, the force applied—which is perpendicular to the wall—forms an acute angle with the lever arm. Thus, even though the forces applied against the walls are the same, the resulting torques are different. The torque applied to the top wall of the waveguide is greater than the torque applied to the bottom wall. Thus, the PTG will rotate in a counterclockwise direction.

End mirrors 24 are positioned perpendicularly to the circulating laser beam 5 at both ends of each waveguide. When the laser beam reaches the end of the waveguide, it strikes the end mirror 24 with a perpendicular angle of incidence. Thus, the end mirror 24 directs the laser beam backward, so that it retraces the same path until it reaches the other end mirror 24. In this configuration, the end mirrors are oriented so that they provide additional torque in the counterclockwise direction.

When using this PTG design, it should be noted that, as the distance from the axis of rotation 6 increases, the difference in the torque produced between the reflections of the circulating laser beam 5 off the upper and lower walls 23 gradually decreases. For example, in the waveguide extending rightward from the shaft 6, at great distances from the axis of rotation 6, the angle made between the lever arm and the force of the radiation pressure against the lower wall will be only slightly less than perpendicular. Given this tendency of the torques to cancel out at great distances from the shaft 6, it is preferable to limit the length of each waveguide, so that a significant torque differential is maintained throughout the waveguide.

For simplicity and to illustrate the basic design, only four waveguides are placed on the photon turbine in FIG. 9. In practice, the entire fairing could be filled with waveguides, which could extend outward from the shaft 6 in every direction, similar to spokes on a wheel. This would maximize the surface area available to receive EM radiation, thereby increasing the potential torque and overall power output of the PTG.

Note that the same basic configuration of the PTG in FIG. 9 could be designed using individual mirrors placed in a series, forming a folded cavity, rather than using a waveguide. However, the waveguide would allow for a greater total surface area, which could potentially receive greater torque from a circulating laser beam. Similar to FIG. 2, the waveguides would extend through the length of the fairing 3. Thus, the waveguides would resemble four planes running through the fairing. Each laser generator 4 would run along the length of the shaft 6 behind the end mirror of its corresponding waveguide.

While the PTG configuration in FIG. 9 uses passive cavities, it could also be designed to use active cavities, where the gain medium is placed inside the waveguides. Alternately, the laser generator 4 could be placed at a separate location and the input laser beam 10 directed into the photon turbine, similar to FIG. 5b or 7b. Directional mirrors on the photon turbine could then guide portions of the input laser beam 10 into the various waveguides.

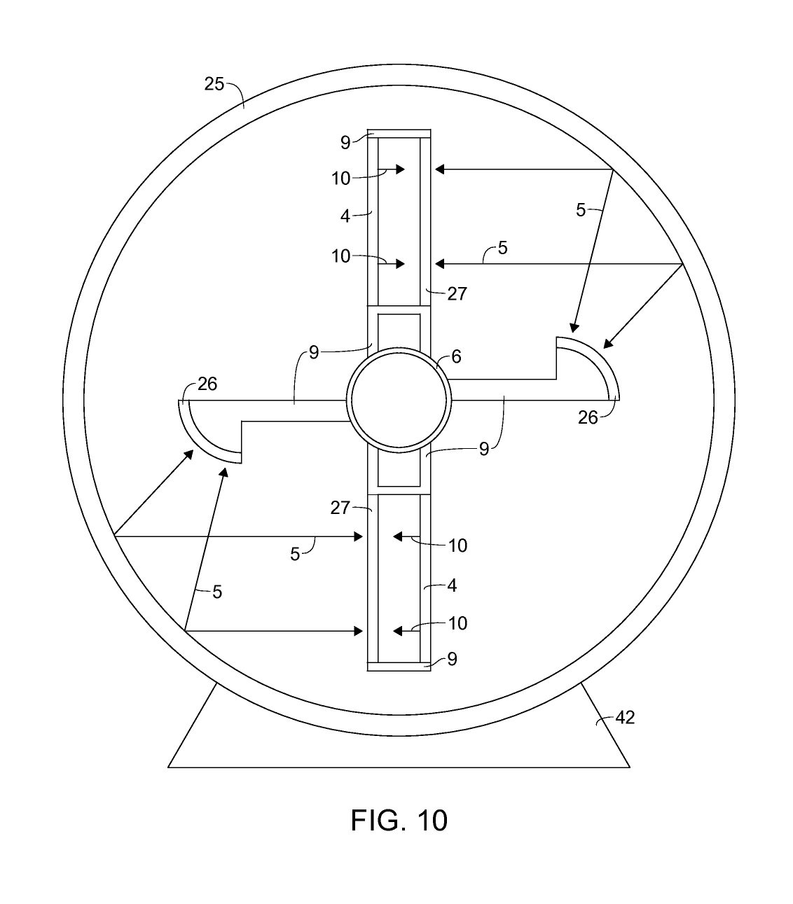

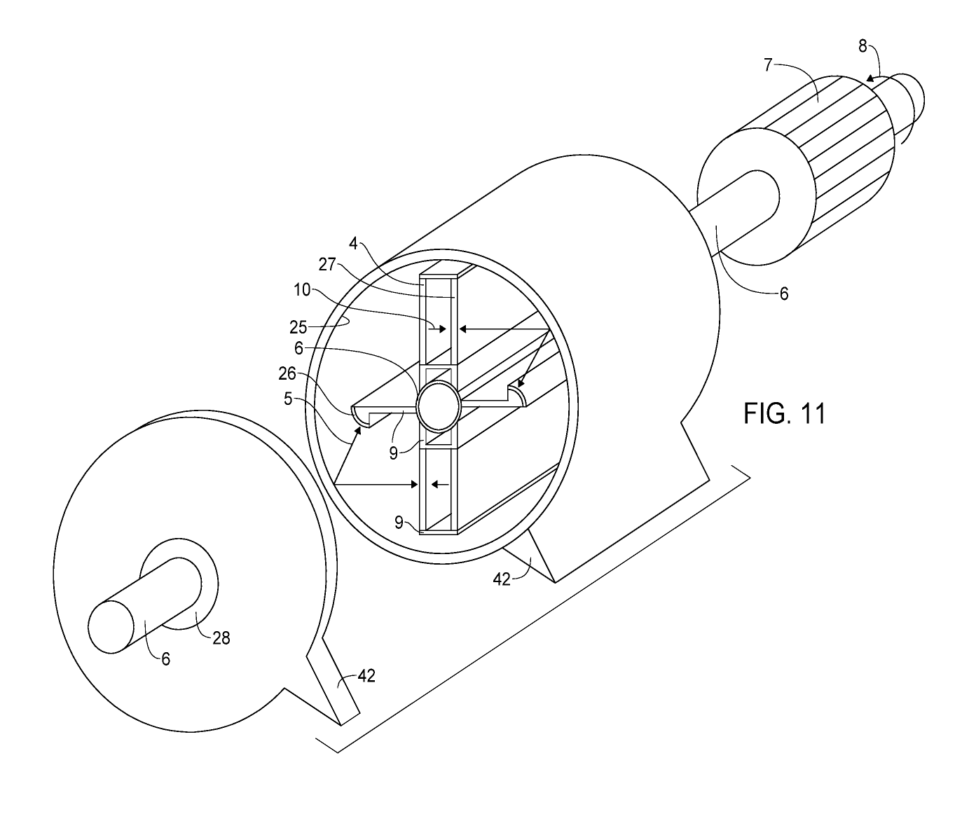

FIGS. 10 and 11 show a PTG based on a resonant cavity that incorporates a fixed, stationary mirror. In this design, the surrounding cylinder 25 does not rotate, but rather is a stationary structure with a high reflectance mirror coating on its interior surface. This fixed structure will form a resonator with the mirrors mounted on the shaft 6, which is placed inside of it. As shown in FIG. 11, seals 28 are placed at the location where the shaft 6 enters the cylinder 25. This will allow the shaft 6 to rotate while enabling the interior of the cylinder 25 to be evacuated for optimal resonator performance. Alternately, the entire cylindrical structure and shaft section of this PTG could be placed inside of a vacuum chamber, while the stator, which surrounds the field windings of the rotor, remains outside of the vacuum chamber. This would make heat dissipation on the rotor more challenging, but it may be a useful design option. Regardless of how the vacuum conditions are established, in this configuration, the shaft 6 will rotate while the cylinder 25, which is mounted on a pedestal base 42, remains stationary.

As shown in FIG. 10, the design of the resonator is broadly similar to a confocal unstable cavity. However, there are a few important differences. The convex mirrors 26 at the ends of the crossbeam 9 are essentially cut in half at the center. Thus, on the right side of the crossbeam 9, the top portion of a convex mirror 26 extends upward. On the left side of the crossbeam 9, the bottom half of a convex mirror 26 extends downward. This helps to produce the imbalance of forces necessary to rotate the shaft 6. The other notable difference from a confocal unstable cavity is the presence of the planar (or long-radius) mirrors 27 positioned on the other crossbeam 9. These planar (or long-radius) mirrors 27 perpendicularly reflect the laser beam 5 that is reflected off the interior wall of the cylinder 25, which acts as a concave mirror, regardless of where the mirrors mounted on the shaft 6 are located at a given time. Thus, the circulating laser beam 5 is reflected directly back to the interior wall of the cylinder 25, which then reflects the circulating laser beam 5 back onto the convex mirror 26. Thus, a folded cavity is formed between the three elements—the convex mirror, the cylindrical (concave) mirror, and the planar (or long-radius) mirror. Because the force applied by the circulating laser beam 5 due to radiation pressure on the planar mirror (or long-radius mirror) 27 is perpendicular to the lever arm, and the force due to radiation pressure on the convex mirror is applied at an acute angle with the lever arm, there is an imbalance of torques, resulting in counterclockwise rotation of the shaft 6.

Because the shaft 6 is placed inside of the cylinder 25, which is a rotationally symmetrical structure, the resonant cavity should be maintained as the shaft 6 rotates. As with other PTG designs, the mirrors will move a very small distance during the time it takes a photon to make one round trip. By using the curved mirror of the cylinder 25 (and, if necessary, a long-radius mirror 27 on the crossbeam 9), along with a feedback control system that may include PZTs or piezo-controlled mirror actuators, the stability of the resonator can be maintained as the shaft 6 rotates.

The requirements for precision control in maintaining resonance between a rotating object and a stationary object suggest that this configuration may be more complex to operate than other configurations discussed in this specification. In addition, some of the force of the radiation pressure is applied to the stationary cylindrical structure 25, and thus does not directly contribute to rotating the shaft 6 (although it does not detract from rotating the shaft 6 either by producing counter-torque). However, this configuration is included here to illustrate a photon turbine with a resonator that comprises both fixed and rotating elements. It is another approach to designing a PTG that may be worthy of consideration.

In contrast to gas turbines or steam turbines, the photon turbine does not rely on heat to cause its rotation. The resonator mirrors generally avoid heat by reflecting nearly all of the EM radiation that strikes their surfaces. Thus, broadly speaking, heat dissipation should be significantly less of a concern in the PTG than in other types of turbines. In addition, heat may be minimized by keeping the power of the circulating laser beam well below the optical damage threshold of the mirrors or reflective surfaces.

It should be noted that the circulating power inside the resonators of the PTG does not have to be near the optical damage threshold of the mirrors. The efficiency of the PTG is a function of the reflectivity of the mirrors. Thus, by using a circulating laser beam that stays well below the optical damage threshold of the resonator mirrors, a PTG could operate at a high level of efficiency while minimizing the risk of mirror damage and reducing the need for active cooling. Applications in which a high power density may be preferable—such as transportation systems—might require the circulating power inside the resonators to be close to the optical damage threshold of the mirrors. However, for a power plant, a high power density is not necessary, as there should be ample space allocated for the PTG. In a power plant, the power of the circulating laser beam could be distributed on mirrors or reflective surfaces with large surface areas, thereby lowering the risk of optical damage and reducing the need for active cooling.

However, even with absorption rates of a small fraction of 1%, the resonator mirrors may be required to withstand a substantial amount of power from the circulating laser beam, which may lead to heat buildup on the mirrors. Furthermore, the vacuum conditions in which the photon turbine may operate may make heat removal more challenging.

Various conventional methods may be used to remove heat from the components of the PTG. The following figures are simply intended to provide a few examples of how heat may be removed from the mirrors or reflective surfaces. There are many other methods, including active and passive techniques, that may be used to remove heat from the mirrors or reflective surfaces, as well as other components of the PTG. The following examples focus on a few methods that may be used to cool the resonator mirrors. Identical or similar techniques may be applied to the other mirrors or reflective surfaces on the photon turbine. Whichever method is used for thermal management of the PTG, it is important to ensure that the method does not interfere with the orientation or reflectivity of the mirrors, or the overall performance of the resonators.

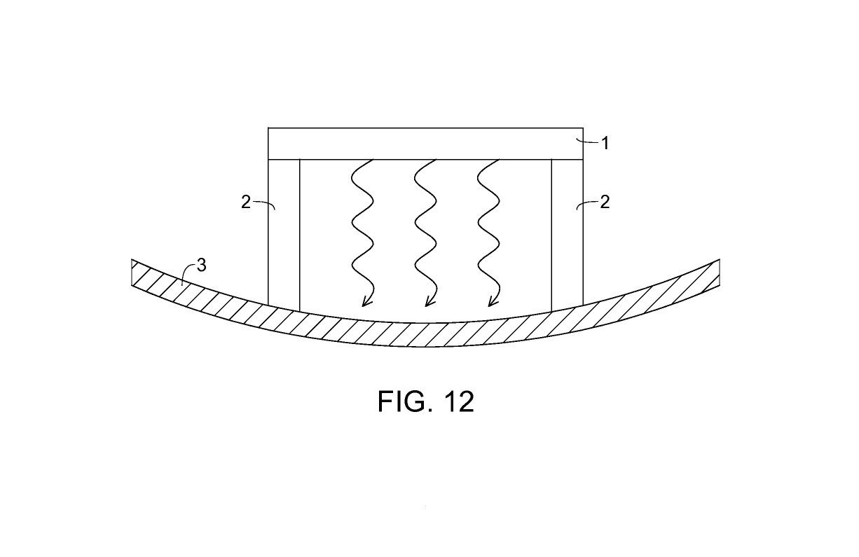

In FIGS. 12-15, various methods of heat removal are shown. Note that these are only a few potential options for heat removal. Many other methods, both active and passive, could be used to remove heat from the resonator mirrors and other components of the photon turbine. Any of the heat transfer methods discussed in this specification may be used alone, in combination with each other, or in combination with other methods not discussed in this specification.

The heat removal mechanisms discussed in this specification focus on the mirrors or reflective surfaces of the PTG. Cooling or thermal management of the gain medium and other components of the PTG may be achieved using conventional means. In some instances, the same method used to cool the resonator mirrors might also be used to cool the gain medium. The structures that secure the gain medium to the photon turbine may be used to provide direct contact cooling of the gain medium. Note that the cooling requirements of the gain medium in an active cavity may be significantly greater than in a passive cavity, as the gain medium would be exposed to the high intensity circulating laser beam in an active cavity. If the laser generator is not located on the photon turbine, and is operated from a separate location, it may facilitate thermal management of the gain medium. For the rotor, stator, exciter, or bearings, conventional means may be used to provide cooling.

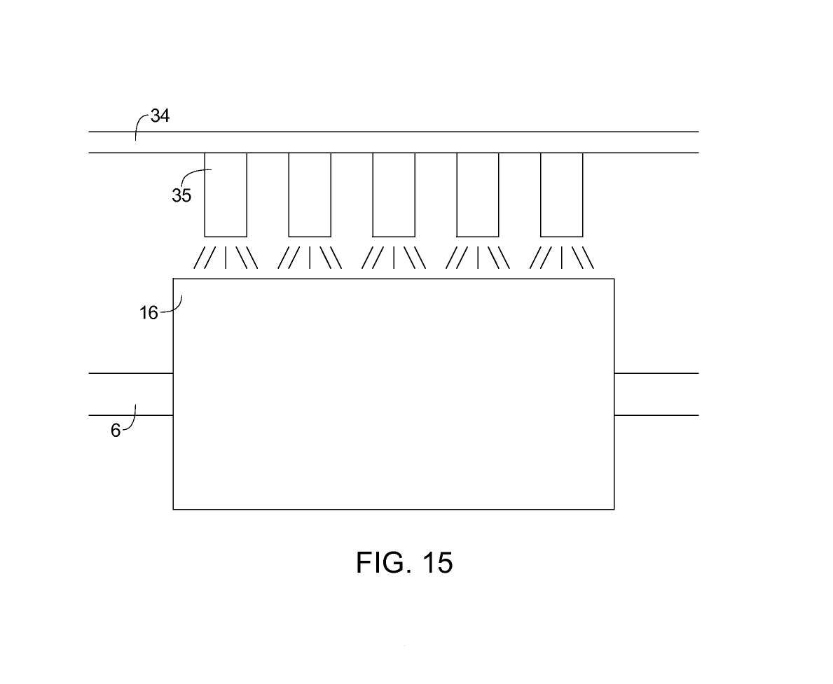

FIG. 12 shows heat transfer by radiation from the back side of a resonator mirror 1. Heat waves are shown between the mirror mounts 2, moving toward the fairing 3. The heat is emitted from the mirror 1, passes through the vacuum, and ultimately is absorbed by the fairing 3. The outer wall of the fairing 3 is in direct contact with the ambient air. Thus, the heat absorbed by the fairing 3 can be removed by direct contact with the ambient air. If necessary, heat removal from the fairing 3 could be facilitated by jets of cold air or other gases, as shown in FIG. 15.

Given the vacuum conditions inside of the fairing, radiative heat transfer may be preferable to other methods. However, if the resonator mirrors cannot maintain optimal performance through radiation of heat, an active cooling system may be necessary.

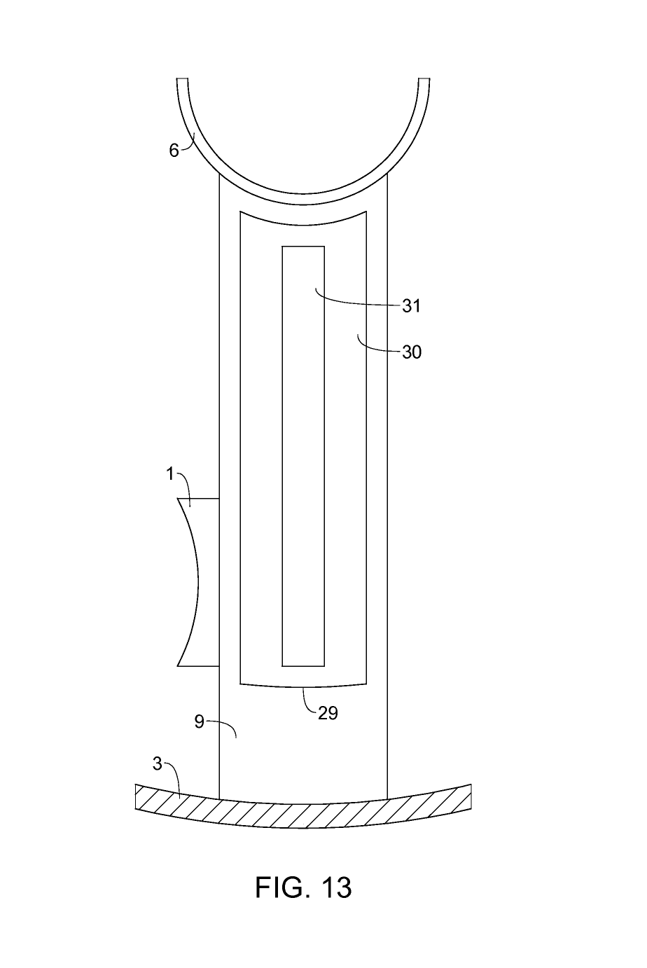

FIG. 13 shows a heat pipe running from the shaft 6 to the back side of a resonator mirror 1 mounted on a crossbeam 9. Heat pipes, which are highly efficient mechanisms of heat transfer, could be especially useful for smaller-sized PTGs, where more active forms of cooling may be less convenient.

The centrifugal force of the rotation of the PTG causes the liquid to flow from the top of the heat pipe 29, near the shaft, to the bottom of the heat pipe 29, adjacent to the mirror 1. The heat pipe 29 may simply be an empty cavity or it may contain grooves 30 or a wick structure to facilitate the movement of the liquid toward the mirror 1. The centrifugal force of the PTG may reduce or eliminate the need for a wick structure or grooves in the heat pipe 29. The liquid will absorb heat from the mirror 1, evaporate, and then travel through the vapor chamber 31 toward the shaft 6. At the opposite end of the heat pipe, adjacent to the shaft, the vapor will condense and begin the cycle again. The outer portion of the shaft 6, adjacent to the top of the heat pipe 29, may be kept at a low temperature by various methods, which may include passing a cold fluid through it axially. Thus, the heat absorbed from the heat pipe may be removed by a cold fluid (liquid or gas) that flows from one end of the shaft to the other. After the fluid exits the shaft and flows away from the PTG, the heat may be transferred from the fluid to the ambient air.

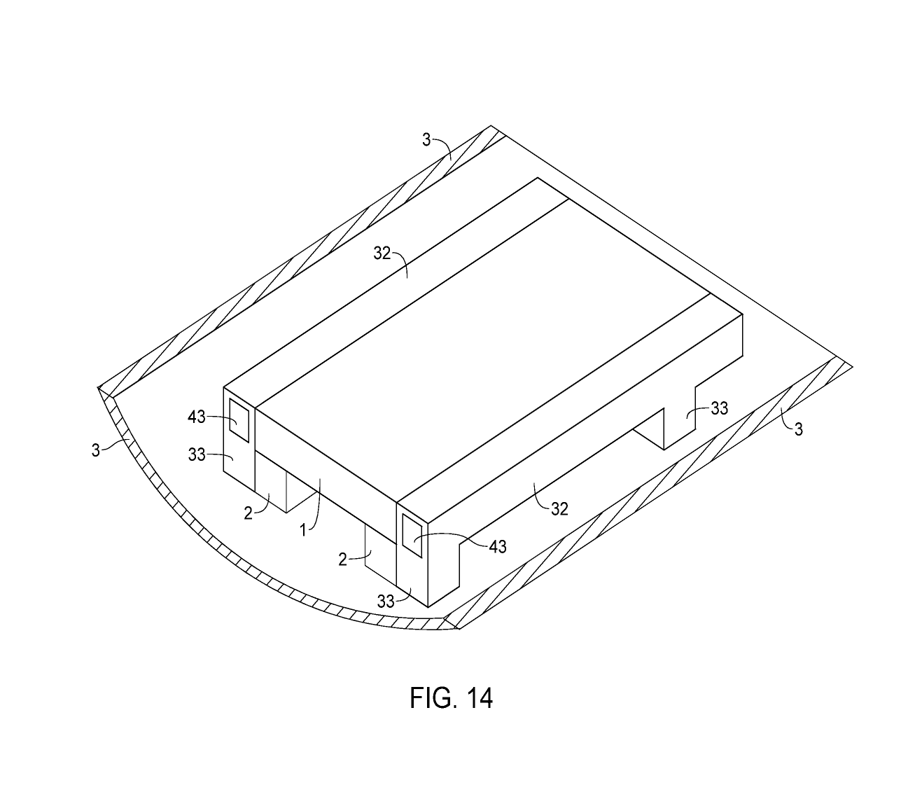

FIG. 14 shows active cooling using conduits 32 that run along the periphery of a resonator mirror 1. The conduits 32 may be mounted 33 on the fairing 3 alongside of the mirror 1. Each conduit 32 provides an open passage 43 for a fluid, such as a liquid or gas, to circulate and remove heat from the mirror 1. A cold fluid can be distributed onto the turbine using conventional means. The cold fluid runs through the conduits 32, along the sides of the mirrors, absorbing heat, and then returns to the source, potentially off the PTG at a nearby location, to dissipate the collected heat. The conduits 32 may be simple linear or planar passages 43, or they may contain microchannels, manifolds, or other means to distribute a cold fluid to the mirror 1.

Various gases or liquids may be used as a coolant, including air or water. In addition, the same substance used to cool the rotor and/or stator may also be used in the conduits. Hydrogen is often used to cool rotors, so it could potentially be used in the conduits to cool the mirrors. However, the use of a flammable substance such as hydrogen in close proximity to high-power lasers could pose a safety risk, and therefore, it may not be a suitable choice for a coolant. Also, if a photon turbine is coupled with a high-temperature superconducting generator, liquid nitrogen could potentially be used in the cooling conduits. Thus many different fluids may be used to cool the mirrors. The particular coolant selected would be based on several factors, including the amount of heat buildup on the mirrors and the optical damage threshold of the mirrors. In practice, any type of head transfer device or mechanism is used. In addition, any type of safety mechanism is used, which may include a protective barrier to contain, disperse, reduce, or eliminate any EM radiation that may escape from the resonators, resonant cavities, or waveguides; a coating on the interior surface that could reflect, scatter, or absorb the EM radiation; and any type of device or component that reduces or minimizes vibrations.

The cooling conduits 32 in FIG. 14 are shown running along the sides of the mirror 1. If necessary, the conduits could also run along the back side of the mirror 1. However, cooling at the sides of the mirror 1 may be preferable, because back side cooling may interfere with the insertion of the input laser beam 10 (if a passive cavity is used). Also, if back side mirror cooling is used, the cooling conduits 32 may have to share space with other components, including mirror mounts and potentially PZT equipment.

It should be noted that if a passive cavity is used in the PTG, one of the resonator mirrors functions as the input mirror, allowing the input laser beam to enter the cavity. The incoming laser beam must not be prevented from entering the resonant cavity by a cooling conduit on the backside of the input mirror. Therefore, cooling of the input mirror could either be limited to its sides or periphery, or, it may be cooled on its back side if both the conduit and the coolant were transparent to the laser beam. Thus, a transparent conduit containing air or water would be able to cool the backside of the mirror while allowing the input laser beam to enter the cavity.

In addition to removing heat from the resonator mirrors, the conduits may also be used to remove heat from other PTG components, including laser pumping devices such as diodes, the gain medium (if it is placed on the turbine), directional mirrors, and electrical wiring.

FIG. 15 shows the cylindrical fairing of the photon turbine being cooled by jets of cold air or gas. The cold air or gas is conveyed to the PTG by a conduit 34 and then distributed onto the fairing through the nozzles 35. With this method, the fairing (or a section of it) is constructed of a material with high thermal conductivity. When the cold air or gas is applied to the surface of the fairing, the temperature of the fairing is reduced, which will then reduce the temperature of the mirror mounts affixed to the interior of the fairing. The reduced temperature of the mirror mounts would then be able to absorb a greater amount of heat from the resonator mirrors. Alternately, the conduit 34 could provide a liquid or mist for the nozzles 35 to apply to the fairing. This method of cooling by jets of air, gas, liquid, or mist might not transfer as much heat as other methods discussed in this specification. However, if only a small amount of heat dissipation is required, this may be a simple and convenient option.

FIG. 16 shows a power plant using a solar-pumped PTG. While a self-pumped configuration of the PTG is preferable, based on its overunity efficiency, a solar-pumped PTG would also be a useful configuration. Rather than using its own power output to produce the input laser, as in the self-pumped configuration, a solar-pumped PTG would use sunlight to produce the input laser.

In FIG. 16, heliostats 36 are used to direct sunlight to a central tower 37. A central deflecting mirror 38 at the top of the central tower 37 deflects the incoming beams downward into a light pipe 39, which delivers the sunlight to a laser generator 4. The sunlight stimulates the gain medium, creating a solar-pumped input laser beam 41, which is distributed to a PTG using guide mirrors 40.

In this drawing, the PTG is shown in an underground facility below the central tower 37 and field of heliostats 36. However, the PTG could also be built aboveground, such as at the base of the central tower 37. For simplicity, FIG. 16 shows only one laser generator 4 and one PTG. However, the solar radiation collected could be applied to many gain media, producing many lasers, which could be distributed to many different PTGs.

The PTG in this drawing uses a laser generator 4 located away from the PTG, rather than placing the laser generator 4 on the photon turbine 16. The input laser beam enters the shaft 6 of the PTG, as previously shown in FIG. 7b. The design of the resonators inside of the fairing could be identical to those shown in FIG. 5a. Or the resonators could be based on FIGS. 8 and 9, but without the laser generator onboard, and with directional mirrors inside of the shaft to distribute the input laser beam to the resonant cavities or waveguides. Alternately, the photon turbine in FIG. 16 could use an entirely different design. In addition, a solar-pumped PTG could also use the method shown in FIG. 4 to insert the input laser beam into the photon turbine. If that method were used, the resonator design may be based on FIG. 1. Furthermore, another option would be to direct the sunlight into the shaft 6 of the PTG and then produce the solar-pumped lasers using laser generators placed onboard the photon turbine, either inside or outside of the resonant cavities or waveguides.

For a given solar collection area, the amount of power that could be generated with a solar-pumped PTG is substantially greater than the power output provided by other forms of solar power, including solar thermal power and photovoltaic power.

The world's current largest solar thermal power plant has a capacity of 354 MW based on a mirror surface area of 6.5 km². Assuming the efficiency of the solar-pumped PTG in FIG. 16 is 470% (identical to the PTG in the sample power calculation), the power output can be calculated as follows:
If the 6.5 km² mirror array receives a solar input of 1 kW/m², the total solar radiation collected is 6.5 GW.

With a PTG operating at 470% efficiency, the power output would be 30.6 GW (6.5 GW×4.7)—approximately 100 times the output the world's largest solar thermal power plant, and substantially greater than most, if not all, conventional power plants.

Even if mirrors of 99.9999% reflectivity were used, instead of the 99.99999% reflectivity assumed in the previous calculation, the power output would still be 3.06 GW.

This power output is still an order of magnitude higher than a solar thermal plant with the equivalent solar collection area. It is also greater than the output of most large conventional power plants. Thus, even when solar pumping is used (as opposed to relying on surplus power from overunity efficiency), the PTG is capable of producing substantially greater output and providing greater efficiency than existing power generators.

It will be appreciated that variants of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

I/We claim:

1. A photon turbine generating apparatus comprising:
a rotor having at least a portion thereof mounted for rotation;
a first reflective surface mounted on the rotor;
a photon resonant cavity defining a closed-loop path iteratively traversed by a photon beam directed into the photon resonant cavity, the closed-loop path including the first reflective surface, wherein the closed loop path including the first reflective surface is arranged to produce a net torque on the rotor in response to photon pressure of the photon beam.

2. The photon turbine generating apparatus according to claim 1, wherein the photon beam comprises electromagnetic radiation from any part of the electromagnetic spectrum.

3. The photon turbine generating apparatus according to claim 2, wherein the photon beam comprises electromagnetic radiation within at least one of the optical, infrared, near-infrared, mid-infrared, far infrared, microwave, ultraviolet, x-ray, gamma ray, or radio portions of the electromagnetic spectrum.

4. The photon turbine generating apparatus according to claim 2, wherein the first reflective surface is optimized to reflect electromagnetic radiation within a first subset of the electromagnetic spectrum, and the photon beam includes electromagnetic radiation having a wavelength within the first subset of the electromagnetic spectrum.

5. The photon turbine generating apparatus according to claim 1, wherein the photon beam is produced by one or more of a solid-state laser, crystal laser, diode laser, semiconductor laser, semiconductor diode laser, fiber laser, photonic crystal fiber laser, gas laser, liquid laser, dye laser, excimer laser, free-electron laser, laser diode stack, laser diode bar, laser diode multi-bar module, laser diode array, two-dimensional diode laser array, broad stripe laser diode, broad area laser diode, broad emitter laser diode, single-emitter laser diode, high brightness diode laser, edge-emitter laser diode, external cavity diode laser, fiber-coupled diode laser, vertical cavity surface-emitting laser, vertical-external-cavity surface-emitting laser, double heterostructure laser, separate confinement heterostructure laser, horiozontal stripe laser, distributed feedback laser, quantum well laser, quantum cascade laser, slab-coupled optical waveguide laser, distributed Bragg reflector laser, Bessel beam, diode-pumped laser, optically pumped laser, laser-pumped laser, light pumped laser, solar pumped laser, nuclear-pumped laser, electric-discharge laser, chemical laser, gas-dynamic laser, ion laser, metal-vapor laser, samarium laser, Raman laser, tunable laser, disk laser, thin-disk laser, rotary disk laser, slab laser, rod laser, spherical laser, optical parametric oscillator, superradiant laser, diffuse random laser, nanostructured laser, nanolasers, vibronic lasers, terahertz laser, microwaves, noncoherent or incoherent light, or sunlight.

6. The photon turbine generating apparatus according to claim 1, further comprising a gain medium operative to produce a photon beam in response to an excitation mounted on the rotor, and configured to direct the produced photon beam into the photon resonant cavity.

7. The photon turbine generating apparatus according to claim 6, further comprising wherein the gain medium is excited by electrical power provided to the rotor.

8. The photon turbine generating apparatus according to claim 1, further comprising a port through which the photon beam is directed into the photon resonant cavity.

9. The photon turbine generating apparatus according to claim 8, wherein the rotor has an axis of rotation, and the port admits the photon beam into the photon resonant cavity substantially aligned with the axis of rotation.

10. The photon turbine generating apparatus according to claim 8, wherein the photon beam is divided into a plurality of photon beams by one or more semi-transparent directional reflective surfaces.

11. The photon turbine generating apparatus according to claim 1, wherein the closed-loop path defined by the photon resonant cavity is a linear, bi-directional path.

12. The photon turbine generating apparatus according to claim 1, further comprising a stationary second reflective surface, the closed-loop path defined by the photon resonant cavity being incident upon the stationary second reflective surface.

13. The photon turbine generating apparatus according to claim 12, further comprising a cylindrical fairing enclosing the rotor, and the stationary second reflective surfaces comprises the interior of the cylindrical fairing.

14. The photon turbine generating apparatus according to claim 13, further comprising a convex third reflective surface, the closed-loop path being incident upon the third reflective surface.

15. The photon turbine generating apparatus according to claim 1, wherein the first reflective surface is at least one of planar, concave or convex.

16. The photon turbine generating apparatus according to claim 1, wherein the photon resonant cavity defines plural discrete closed-loop paths arranged longitudinally on the rotor.

17. The photon turbine generating apparatus according to claim 1, further comprising a waveguide extending radially outward from an axis of rotation of the rotor, the first reflective surface being an end mirror at a distal end of the waveguide, the closed-loop path being at least partially internal to the waveguide and incident upon the first reflective surface.

18. The photon turbine generating apparatus according to claim 1, further comprising a heat sink, and a thermally conductive path between the first reflective surface and the heat sink.

19. The photon turbine generating apparatus according to claim 18, wherein the heat sink in one of a central shaft of the rotor, and an enclosure surrounding the rotor.

20. The photon turbine generating apparatus according to claim 18, wherein the thermally conductive path comprises one or more of a radiation pathway including a radiantly absorbing surface, a heat pipe, a fluid conduit through which a coolant circulates, and a coolant fluid bathed on an enclosure including the photon resonant cavity.

21. The photon turbine generating apparatus according to claim 1, further comprising an at least partially evacuated enclosure within which the rotor turns.

22. The photon turbine generating apparatus according to claim 1, wherein the rotor is operatively connected with an electrical generator.

23. The photon turbine generating apparatus according to claim 22, wherein a portion of power supplied by the electrical generator is consumed by at least one of exciting a gain medium producing the photon beam and powering a control system controlling operation of the photon turbine generator.

24. The photon turbine generating apparatus according to claim 1, further comprising an actuator operative to adjust alignment of the first reflective surface to maintain the integrity of the closed-loop path.

25. The photon turbine generating apparatus according to claim 24, wherein the actuator comprises a piezo-electric actuator.
